(19) United States
(12) Patent Application Publication
(10) Pub. No.: US 2012/0107712 A1
(43) Pub. Date: May 3, 2012

(54) METHOD FOR OPERATING A FUEL CELL, AND A CORRESPONDING FUEL CELL

(75) Inventors: Thomas Justus Schmidt, Morfelden-Walldorf (DE); Jochen Baurmeister, Eppstein (DE)

(73) Assignee: BASF SE, Ludwigshafen (DE)

(21) Appl. No.: 13/383,316

(22) PCT Filed: Jul. 9, 2010
(86) PCT No.: PCT/EP2010/004210

§ 371 Date: Jan. 10, 2012

(30) Foreign Application Priority Data
Jul. 16, 2009 (EP) 09009249.5

(51) Int. Cl. H01M 8/04; H01M 8/10

(52) U.S. Cl. 429/447; 429/480

(57) ABSTRACT

The present invention relates to a process for operating a fuel cell, especially for operating a fuel cell in which the electrolyte responsible for the proton conduction is volatile.

By means of the process according to the invention, better operation of such a fuel cell is possible, and they exhibit an improved lifetime.

The present invention relates to a process for operating a fuel cell, especially for operating a fuel cell in which the electrolyte responsible for the proton conduction is volatile. By means of the process according to the invention, better operation of such fuel cells is possible, and they exhibit an improved lifetime.

In polymer electrolyte membrane (PEM) fuel cells, the proton-conducting membranes used nowadays are almost exclusively sulfonic acid-modified polymers. Predominantly perfluorinated polymers are employed. A prominent example thereof is Nafion™ from DuPont de Nemours, Wilmington, USA. For proton conduction, a relatively high water content in the membrane is required, which is typically 4-20 molecules of water per sulfonic acid group. The water content needed, but also the stability of the polymer in conjunction with acidic water and the hydrogen and oxygen reaction gases, limits the operating temperature of the PEM fuel cell stacks to 80-100° C. Higher operating temperatures cannot be achieved without loss of performance of the fuel cell. At temperatures above the dew point of water for a given pressure level, the membrane dries out completely, and the fuel cell no longer supplies any electrical energy since the resistance of the membrane rises to such high values that there is no longer any significant current flow.

A membrane electrode assembly based on the technology detailed above is described, for example, in U.S. Pat. No. 5,464,700.

For system-related reasons, however, higher operating temperatures than 100° C. in the fuel cell are desirable. The activity of the noble-metal-based catalysts present in the membrane electrode assembly (MEA) is much better at high operating temperatures.

More particularly, in the case of use of what are called reformates from hydrocarbons, distinct amounts of carbon monoxide are present in the reformer gas and typically have to be removed by a costly and inconvenient gas processing or gas cleaning operation. At high operating temperatures, the tolerance of the catalysts to the CO impurities rises.

In addition, heat arises in the operation of fuel cells. However, cooling of these systems to below 80° C. can be very costly and inconvenient. According to the power released, the cooling apparatus can be made much simpler. This means that, in fuel cell systems which are operated at temperatures above 100° C., the waste heat can be utilized much better and hence the fuel cell system efficiency can be enhanced.

In order to attain these temperatures, membranes with novel conductivity mechanisms are generally used. One approach for this purpose is the use of membranes which exhibit ionic conductivity without the use of water. The first promising development in this direction is detailed in the document WO96/13872.

Further high-temperature fuel cells are described in JP-A-2001-196082 and DE 10235360, with particular examination of the seal systems of the electrode membrane assembly.

The aforementioned membrane electrode assemblies are generally connected with planar bipolar plates into which channels for a gas flow are cut. Since some of the membrane electrode assemblies have a greater thickness than the seals described above, a seal, which is typically produced from PTFE, is placed between the seal of the membrane electrode assemblies and the bipolar plates.

It has now been found that fuel cells in which the electrolyte responsible for the proton conduction is volatile, especially in the case of noncontinuous operation, have reduced lifetime and performance. The performance loss observed is only partly reversible, i.e. is only partly reversibly compensated in subsequent operation, such that the lifetime is reduced further.

It is an object of the present invention to avoid these performance losses and to avoid the reduction in lifetime.

This/these object(s), and also further object(s) not stated explicitly, are achieved by the process according to claim 1.

The present invention accordingly provides a process for operating a fuel cell comprising
(i) a proton-conducting polymer electrolyte membrane or polymer electrolyte matrix which has at least one electrolyte whose partial vapor pressure at 100° C. is below 0.300 bar, preferably below 0.250 bar and more preferably below 0.200 bar,
(ii) at least one catalyst layer present on both sides of the proton-conducting polymer electrolyte membrane or polymer electrolyte matrix,
(iii) at least one electrically conductive gas diffusion layer present on the two outer sides of the catalyst layer,
(iv) at least one bipolar plate present on the two outer sides of the gas diffusion layer,
   comprising the following steps:
a) supplying a hydrogenous gas by means of the gas channels present in the bipolar plate through the gas diffusion layer to the catalyst layer on the anode side,
b) supplying a gas mixture comprising oxygen and nitrogen by means of the gas channels present in the bipolar plate through the gas diffusion layer to the catalyst layer on the cathode side,
c) generation of protons at the catalyst layer on the anode side,
d) diffusion of the protons generated through the proton-conducting polymer electrolyte membrane or polymer electrolyte matrix,
e) reaction of the protons with the oxygenous gas supplied on the cathode side,
f) tapping of the voltage potential formed via the bipolar plates on the anode side and on the cathode side,
   wherein at least the hydrogenous gas supplied is enriched with at least one electrolyte which is responsible for the proton conduction and whose partial vapor pressure at 100° C. is below 0.300 bar, preferably below 0.250 bar and more preferably below 0.200 bar.

### Proton-Conducting Polymer Electrolyte Membranes and Matrices

Polymer electrolyte membranes and polymer electrolyte matrices suitable for the purposes of the present invention are known per se.

In the context of the present invention, electrolytes included in the polymer electrolyte membranes or polymer electrolyte matrices have a partial vapor pressure at 100° C. below 0.300 bar, preferably below 0.250 bar and more preferably below 0.200 bar. The electrolytes encompassed by the present invention are in liquid form at 100° C. and standard pressure (1013 hPa). The polymer electrolyte membranes or polymer electrolyte matrices encompassed by the invention comprise at least one electrolyte bonded noncovalently to the polymer of the polymer electrolyte membranes or polymer electrolyte matrices. Electrolytes encompassed by the present invention are those which may also comprise water as well as acids. Pure water as an electrolyte is not encompassed by the present invention.

The electrolytes present in accordance with the invention are acids which are present bound in the polymer electrolyte membranes or polymer electrolyte matrices by acid-base interactions. The acids involved here are preferably Lewis and/or Brønsted acids, preferably inorganic Lewis and Brønsted acids, especially Brønsted acids, more preferably mineral acids. Particular preference is given to phosphoric acid and derivatives thereof, especially to those derivatives which release phosphoric acid under the action of temperatures in the range from 60 to 220° C.

In addition, hydrolysis products of organic phosphonic anhydrides, i.e. organophosphonic acids, can also be understood as an electrolyte.

These form through hydrolysis of organic phosphonic anhydrides.

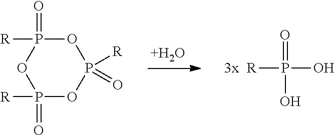

The parent organic phosphonic anhydrides are cyclic compounds of the formula

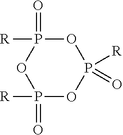

or linear compounds of the formula

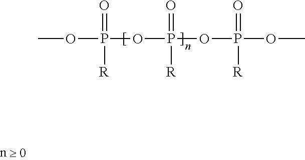

or anhydrides of the multiple organic phosphonic acids, for example of the formula of the anhydride of diphosphonic acid

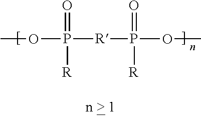

in which the R and R′ radicals are the same or different and are each a C₁-C₂₀ group.

In the context of the present invention, a C₁-C₂₀ group is preferably understood to mean the C₁-C₂₀-alkyl radicals, more preferably methyl, ethyl, n-propyl, i-propyl, n-butyl, i-butyl, s-butyl, t-butyl, n-pentyl, s-pentyl, cyclopentyl, n-hexyl, cyclohexyl, n-octyl or cyclooctyl, C₁-C₂₀-alkenyl, more preferably ethenyl, propenyl, butenyl, pentenyl, cyclopentenyl, hexenyl, cyclohexenyl, octenyl or cyclooctenyl, C₁-C₂₀-alkynyl, more preferably ethynyl, propynyl, butynyl, pentynyl, hexynyl or octynyl, C₆-C₂₀-aryl, more preferably phenyl, biphenyl, naphthyl or anthracenyl, C₁-C₂₀-fluoroalkyl, more preferably trifluoromethyl, pentafluoroethyl or 2,2,2-trifluoroethyl, C₆-C₂₀-aryl, more preferably phenyl, biphenyl, naphthyl, anthracenyl, triphenylenyl, [1,1′;3′,1″]terphenyl-2′-yl, binaphthyl or phenanthrenyl, C₆-C₂₀-fluoroaryl, more preferably tetrafluorophenyl or heptafluoronaphthyl, C₁-C₂₀-alkoxy, more preferably methoxy, ethoxy, n-propoxy, i-propoxy, n-butoxy, i-butoxy, s-butoxy or t-butoxy, C₆-C₂₀-aryloxy, more preferably phenoxy, naphthoxy, biphenyloxy, anthracenyloxy, phenanthrenyloxy, C₇-C₂₀-arylalkyl, more preferably o-tolyl, m-tolyl, p-tolyl, 2,6-dimethylphenyl, 2,6-diethylphenyl, 2,6-di-i-propylphenyl, 2,6-di-t-butylphenyl, o-t-butylphenyl, m-t-butylphenyl, p-t-butylphenyl, C₇-C₂₀-alkylaryl, more preferably benzyl, ethylphenyl, propylphenyl, diphenylmethyl, triphenylmethyl or naphthalenylmethyl, C₇-C₂₀-aryloxyalkyl, more preferably o-methoxyphenyl, m-phenoxymethyl, p-phenoxymethyl, C₁₂-C₂₀-aryloxyaryl, more preferably p-phenoxyphenyl, C₅-C₂₀-heteroaryl, more preferably 2-pyridyl, 3-pyridyl, 4-pyridyl, quinolinyl, isoquinolinyl, acridinyl, benzoquinolinyl or benzoisoquinolinyl, C₄-C₂₀-heterocycloalkyl, more preferably furyl, benzofuryl, 2-pyrrolidinyl, 2-indolyl, 3-indolyl, 2,3-dihydroindolyl, C₈-C₂₀-arylalkenyl, more preferably o-vinylphenyl, m-vinylphenyl, p-vinylphenyl, C₈-C₂₀-arylalkynyl, more preferably o-ethynylphenyl, m-ethynylphenyl or p-ethynylphenyl, C₂-C₂₀ heteroatom-containing group, more preferably carbonyl, benzoyl, oxybenzoyl, benzoyloxy, acetyl, acetoxy or nitrile, and one or more C₁-C₂₀ groups may form a cyclic system.

In the aforementioned C₁-C₂₀ groups, one or more nonadjacent CH₂ groups may be replaced by —O—, —S—, —NR¹— or —CONR²—, and one or more hydrogen atoms may be replaced by F.

In the aforementioned C₁-C₂₀ groups which may have aromatic systems, one or more nonadjacent CH groups may be replaced by —O—, —S—, —NR¹— or —CONR²—, and one or more hydrogen atoms may be replaced by F.

The R¹ and R² radicals are the same or different at each instance and are H or an aliphatic or aromatic hydrocarbyl radical having 1 to 20 carbon atoms.

Particular preference is given to organic phosphonic anhydrides which are partly fluorinated or perfluorinated.

The organic phosphonic anhydrides are commercially available, for example the T3P® (propanephosphonic anhydride) product from Clariant.

The single and/or multiple organic phosphonic acids are compounds of the formula

R—PO₃H₂

H₂O₃P—R—PO₃H₂

R—[PO₃H₂]ₙ

n>2

in which the R radical is the same or different and is a C₁-C₂₀ group.

In the context of the present invention, a C₁-C₂₀ group is preferably understood to mean the C₁-C₂₀-alkyl radicals, more preferably methyl, ethyl, n-propyl, i-propyl, n-butyl, i-butyl, s-butyl, t-butyl, n-pentyl, s-pentyl, cyclopentyl, n-hexyl, cyclohexyl, n-octyl or cyclooctyl, C₆-C₂₀-aryl, more preferably phenyl, biphenyl, naphthyl or anthracenyl, C₁-C₂₀-fluoroalkyl, more preferably trifluoromethyl, pentafluoroethyl or 2,2,2-trifluoroethyl, C₆-C₂₀-aryl, more preferably phenyl, biphenyl, naphthyl, anthracenyl, triphenylenyl, [1,1′;3′,1″]terphenyl-2′-yl, binaphthyl or phenanthrenyl, C₆-C₂₀-fluoroaryl, more preferably tetrafluorophenyl or heptafluoronaphthyl, C₁-C₂₀-alkoxy, more preferably methoxy, ethoxy, n-propoxy, i-propoxy, n-butoxy, i-butoxy, s-butoxy or t-butoxy, C₆-C₂₀-aryloxy, more preferably phenoxy, naphthoxy, biphenyloxy, anthracenyloxy, phenanthrenyloxy, C₇-C₂₀-arylalkyl, more preferably o-tolyl, m-tolyl, p-tolyl, 2,6-dimethylphenyl, 2,6-diethylphenyl, 2,6-di-i-propylphenyl, 2,6-di-t-butylphenyl, o-t-butylphenyl, m-t-butylphenyl, p-t-butylphenyl, C₇-C₂₀-alkylaryl, more preferably benzyl, ethylphenyl, propylphenyl, diphenylmethyl, triphenylmethyl or naphthalenylmethyl, C₇-C₂₀-aryloxyalkyl, more preferably o-methoxyphenyl, m-phenoxymethyl, p-phenoxymethyl, C₁₂-C₂₀-aryloxyaryl, more preferably p-phenoxyphenyl, C₅-C₂₀-heteroaryl, more preferably 2-pyridyl, 3-pyridyl, 4-pyridyl, quinolinyl, isoquinolinyl, acridinyl, benzoquinolinyl or benzoisoquinolinyl, C₄-C₂₀-heterocycloalkyl, more preferably furyl, benzofuryl, 2-pyrrolidinyl, 2-indolyl, 3-indolyl, 2,3-dihydroindolyl, C₂-C₂₀ heteroatom-containing group, more preferably carbonyl, benzoyl, oxybenzoyl, benzoyloxy, acetyl, acetoxy or nitrile, and one or more C₁-C₂₀ groups may form a cyclic system.

In the aforementioned C₁-C₂₀ groups, one or more nonadjacent CH₂ groups may be replaced by —O—, —S—, —NR¹— or —CONR²—, and one or more hydrogen atoms may be replaced by F.

In the aforementioned C₁-C₂₀ groups which may have aromatic systems, one or more nonadjacent CH groups may be replaced by —O—, —S—, —NR¹— or —CONR²—, and one or more hydrogen atoms may be replaced by F.

The R¹ and R² radicals are the same or different at each instance and are H or an aliphatic or aromatic hydrocarbyl radical having 1 to 20 carbon atoms.

Particular preference is given to organic phosphonic acids which are partly fluorinated or perfluorinated.

The organic phosphonic acids are commercially available, for example the products from Clariant or Aldrich.

Especially the use of organophosphonic acids, particularly of partly fluorinated or perfluorinated organophosphonic acids, leads to an unexpected reduction in overvoltage, especially at the cathode in a membrane electrode assembly.

In the context of the present invention, organophosphonic acids, partly fluorinated or perfluorinated organophosphonic acids, and hydrolysis products of organic phosphonic anhydrides, are understood to mean only those substances which do not have any vinyl-containing groups.

In one variant of the process according to the invention, it is also possible to add various electrolytes to the gas supplied, especially to the hydrogenous gas. This variant is especially advantageous when the composition of the gases supplied, especially of the hydrogenous gases, is subject to variations.

The electrolyte(s) may, as well as the substances mentioned, also have further additives, excluding water. Such additives are preferably substances and compounds which are compatible with the electrolyte. Suitable additives are especially partly fluorinated or perfluorinated organic compounds, more preferably perfluorinated sulfoamides, methanesulfonic acid and derivatives thereof, and also pentafluorophenol, though the above list should not be regarded as conclusive.

In general, membranes comprising acids are used, and the acids may also be partially covalently bonded to polymers. The acid-comprising membranes can be obtained by doping a flat material with one or more acids. These acids are responsible for the proton conduction, but also exhibit volatility, such that they are discharged in the course of operation of the fuel cell.

The scope of the present invention encompasses fuel cells or polymer electrolyte membranes or polymer electrolyte matrices whose proton-conducting polymer electrolyte membrane or polymer electrolyte matrix comprises at least one electrolyte whose partial vapor pressure at 100° C. is below 0.300 bar, preferably below 0.250 bar and more preferably below 0.200 bar.

These doped membranes can be produced by methods including swelling of flat materials, for example of a polymer film, with a liquid comprising acid-containing compounds, or by production of a mixture of polymers and acid-containing compounds and subsequent formation of a membrane by forming a flat article and then solidifying to form a membrane.

Polymers suitable for this purpose include polyolefins such as poly(chloroprene), polyacetylene, polyphenylene, poly(p-xylylene), polyarylmethylene, polystyrene, polymethylstyrene, polyvinyl alcohol, polyvinyl acetate, polyvinyl ether, polyvinylamine, poly(N-vinylacetamide), polyvinylimidazole, polyvinylcarbazole, polyvinylpyrrolidone, polyvinylpyridine, polyvinyl chloride, polyvinylidene chloride, polytetrafluoroethylene, polyhexafluoropropylene, copolymers of PTFE with hexafluoropropylene, with perfluoropropyl vinyl ether, with trifluoronitrosomethane, with carbalkoxyperfluoroalkoxyvinyl ether, polychlorotrifluoroethylene, polyvinyl fluoride, polyvinylidene fluoride, polyacrolein, polyacrylamide, polyacrylonitrile, polycyanoacrylates, polymethacrylimide, cycloolefinic copolymers, especially those of norbornene;

polymers having C—O bonds in the backbone, for example polyacetal, polyoxymethylene, polyethers, polypropylene oxide, polyepichlorohydrin, polytetrahydrofuran, polyphenylene oxide, polyether ketone, polyesters, especially polyhydroxyacetic acid, polyethylene terephthalate, polybutylene terephthalate, polyhydroxybenzoate, polyhydroxypropionic acid, polypivalolactone, polycaprolactone, polymalonic acid, polycarbonate;
polymers C—S bonds in the backbone, for example polysulfide ethers, polyphenylene sulfide, polysulfones, polyether sulfone;
polymers C—N bonds in the backbone, for example polyimines, polyisocyanides, polyetherimine, polyetherimides, polyaniline, polyaramids, polyamides, polyhydrazides, polyurethanes, polyimides, polyazoles, polyazole ether ketone, polyazines;
liquid-crystalline polymers, especially Vectra, and
inorganic polymers, for example polysilanes, polycarbosilanes, polysiloxanes, polysilicic acid, polysilicates, silicones, polyphosphazenes and polythiazyl.

Preference is given here to basic polymers, which applies especially to membranes doped with acids. Useful acid-doped basic polymer membranes include virtually all known polymer membranes in which the protons can be transported. Preference is given here to acids which can convey protons without additional water, for example by means of what is called the Grotthus mechanism.

The basic polymer used in the context of the present invention is preferably a basic polymer having at least a nitrogen atom in a repeat unit.

The repeat unit in the basic polymer comprises, in a preferred embodiment, an aromatic ring having at least one nitrogen atom. The aromatic ring is preferably a five- or six-membered ring having one to three nitrogen atoms, which may be fused to another ring, especially another aromatic ring.

In a particular aspect of the present invention, polymers of high thermal stability which comprise at least one nitrogen, oxygen and/or sulfur atom in one repeat unit or in different repeat units are used.

A polymer having “high thermal stability” in the context of the present invention is one which can be operated for a prolonged period as a polymeric electrolyte in a fuel cell at temperatures above 120° C. “For a prolonged period” means that an inventive membrane can be operated for at least 100 hours, preferably at least 500 hours, at least 80° C., preferably at least 120° C., more preferably at least 160° C., without any decrease in the performance, which can be measured by the method described in WO 01/18894 A2, by more than 50%, based on the starting performance. In addition, polymer electrolyte membranes of high thermal stability or polymer electrolyte matrices of high thermal stability are understood to mean those having a proton conductivity of at least 1 mS/cm, preferably at least 2 mS/cm and especially at least 5 mS/cm at temperatures of 120° C. These values are achieved here without moistening.

The aforementioned polymers can be used individually or as a mixture (blend). Preference is given here especially to blends which comprise polyazoles and/or polysulfones. The preferred blend components are polyether sulfone, polyether ketone and polymers modified with sulfonic acid groups as described in WO 02/36249. The use of blends can improve the mechanical properties and reduce the material costs.

A particularly preferred group of basic polymers is that of polyazoles. Polyazoles are understood to mean polymers which have heteroaromatic rings or heteroaromatic ring systems in a repeat unit, where the heteroatoms may be selected from the group of N, O, S and/or P. Polyazoles preferably comprise at least nitrogen as heteroatoms.

A basic polymer based on polyazole comprises repeat azole units of the general formula (I) and/or (II) and/or (III) and/or (IV) and/or (V) and/or (VI) and/or (VII) and/or (VIII) and/or (IX) and/or (X) and/or (XI) and/or (XII) and/or (XIII) and/or (XIV) and/or (XV) and/or (XVI) and/or (XVII) and/or (XVIII) and/or (XIX) and/or (XX) and/or (XXI) and/or (XXII)

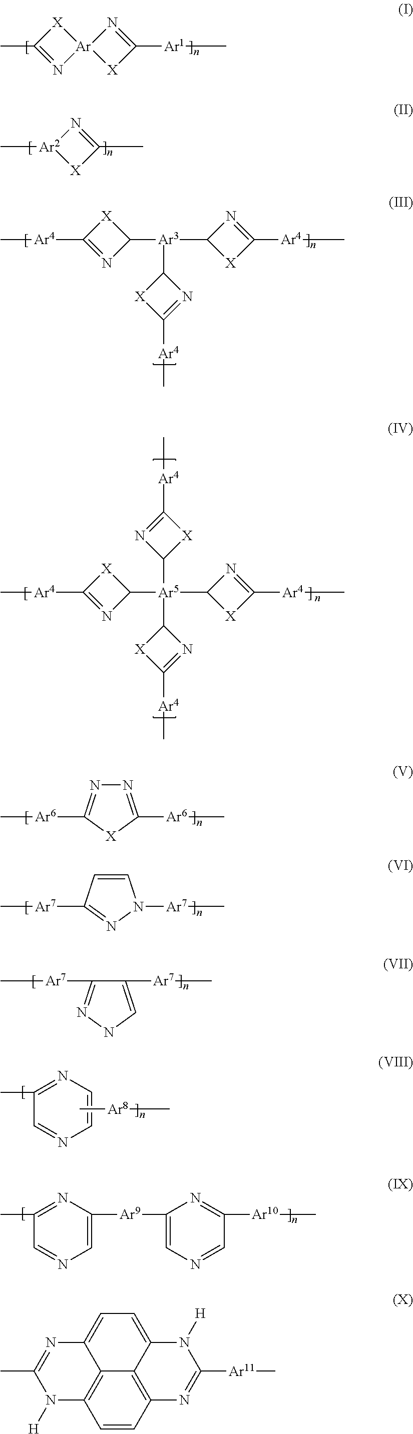

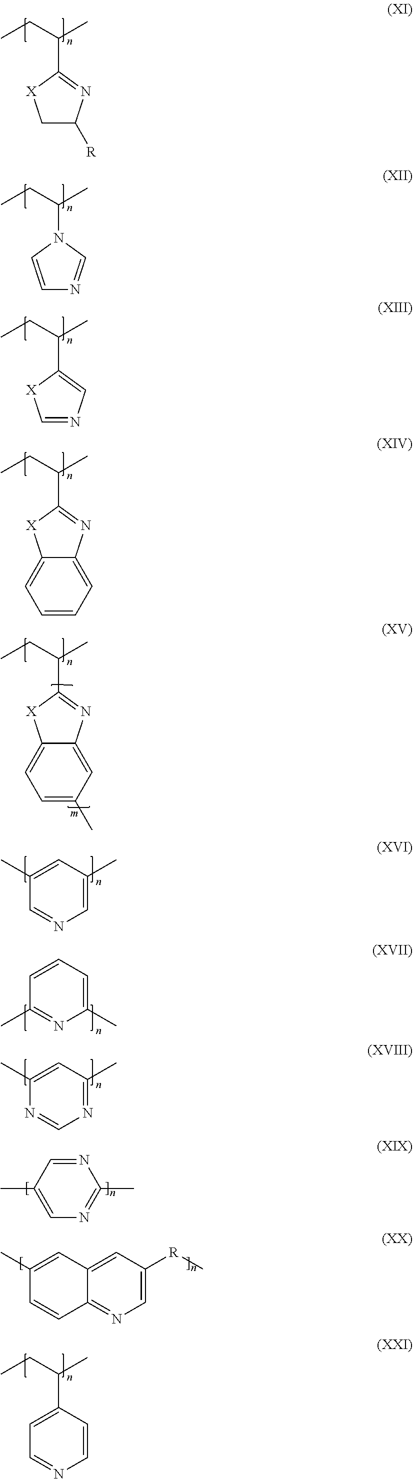

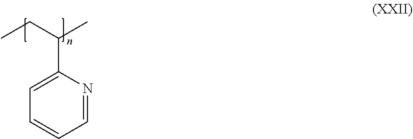

in which
Ar are the same or different and are each a tetravalent aromatic or heteroaromatic group which may be mono- or polycyclic,
Ar¹ are the same or different and are each a divalent aromatic or heteroaromatic group which may be mono- or polycyclic,
Ar² are the same or different and are each a di- or trivalent aromatic or heteroaromatic group which may be mono- or polycyclic,
Ar³ are the same or different and are each a trivalent aromatic or heteroaromatic group which may be mono- or polycyclic,
Ar⁴ are the same or different and are each a trivalent aromatic or heteroaromatic group which may be mono- or polycyclic,
Ar⁵ are the same or different and are each a tetravalent aromatic or heteroaromatic group which may be mono- or polycyclic,
Ar⁶ are the same or different and are each a divalent aromatic or heteroaromatic group which may be mono- or polycyclic,
Ar⁷ are the same or different and are each a divalent aromatic or heteroaromatic group which may be mono- or polycyclic,
Ar⁸ are the same or different and are each a trivalent aromatic or heteroaromatic group which may be mono- or polycyclic,
Ar⁹ are the same or different and are each a di- or tri- or tetravalent aromatic or heteroaromatic group which may be mono- or polycyclic,
Ar¹⁰ are the same or different and are each a di- or trivalent aromatic or heteroaromatic group which may be mono- or polycyclic,
Ar¹¹ are the same or different and are each a divalent aromatic or heteroaromatic group which may be mono- or polycyclic,
X is the same or different and is oxygen, sulfur or an amino group which bears a hydrogen atom, a group having 1-20 carbon atoms, preferably a branched or unbranched alkyl or alkoxy group, or an aryl group as further radical,
R is the same or different and is hydrogen, an alkyl group or an aromatic group, with the proviso that R in formula (XX) is not hydrogen, and
n, m is an integer greater than or equal to 10, preferably greater than or equal to 100.

Preferred aromatic or heteroaromatic groups derive from benzene, naphthalene, biphenyl, diphenyl ether, diphenylmethane, diphenyldimethylmethane, bisphenone, diphenylsulfone, quinoline, pyridine, bipyridine, pyridazine, pyrimidine, pyrazine, triazine, tetrazine, pyrrole, pyrazole, anthracene, benzopyrrole, benzotriazole, benzoxathiadiazole, benzoxadiazole, benzopyridine, benzopyrazine, benzopyrazidine, benzopyrimidine, benzopyrazine, benzotriazine, indolizine, quinolizine, pyridopyridine, imidazopyrimidine, pyrazinopyrimidine, carbazole, aciridine, phenazine, benzoquinoline, phenoxazine, phenothiazine, acridizine, benzopteridine, phenanthroline and phenanthrene, which may optionally also be substituted.

The substitution pattern of Ar¹, Ar⁴, Ar⁶, Ar⁷, Ar⁸, Ar⁹, Ar¹⁰, Ar¹¹ is as desired; in the case of phenylene, for example, Ar¹, Ar⁴, Ar⁶, Ar⁷, Ar⁸, Ar⁹, Ar¹⁰, Ar¹¹ may be ortho-, meta- and para-phenylene. Particularly preferred groups derive from benzene and biphenylene, which may optionally also be substituted.

Preferred alkyl groups are short-chain alkyl groups having 1 to 4 carbon atoms, for example methyl, ethyl, n- or i-propyl and t-butyl groups.

Preferred aromatic groups are phenyl or naphthyl groups. The alkyl groups and the aromatic groups may be substituted.

Preferred substituents are halogen atoms, for example fluorine, amino groups, hydroxy groups or short-chain alkyl groups, for example methyl or ethyl groups.

Preference is given to polyazoles having repeat units of the formula (I) in which the X radicals are the same within one repeat unit.

The polyazoles may in principle also have different repeat units which differ, for example, in their X radical. However, it preferably has only identical X radicals in one repeat unit.

Further preferred polyazole polymers are polyimidazoles, polybenzothiazoles, polybenzoxazoles, polyoxadiazoles, polyquinoxalines, polythiadiazoles, poly(pyridines), poly(pyrimidines) and poly(tetraazapyrenes).

In a further embodiment of the present invention, the polymer comprising repeat azole units is a copolymer or a blend which comprises at least two units of the formulae (I) to (XXII) which differ from one another. The polymers may be in the form of block copolymers (diblock, triblock), random copolymers, periodic copolymers and/or alternating polymers. Particular preference is given to what are called segment block polymers, especially as disclosed in WO2005/011039.

In a particularly preferred embodiment of the present invention, the polymer comprising repeat azole units is a polyazole which comprises only units of the formula (I) and/or (II).

The number of repeat azole units in the polymer is preferably an integer greater than or equal to 10. Particularly preferred polymers comprise at least 100 repeat azole units.

In the context of the present invention, preference is given to polymers comprising repeat benzimidazole units. Some examples of the highly appropriate polymers comprising repeat benzimidazole units are represented by the following formulae:

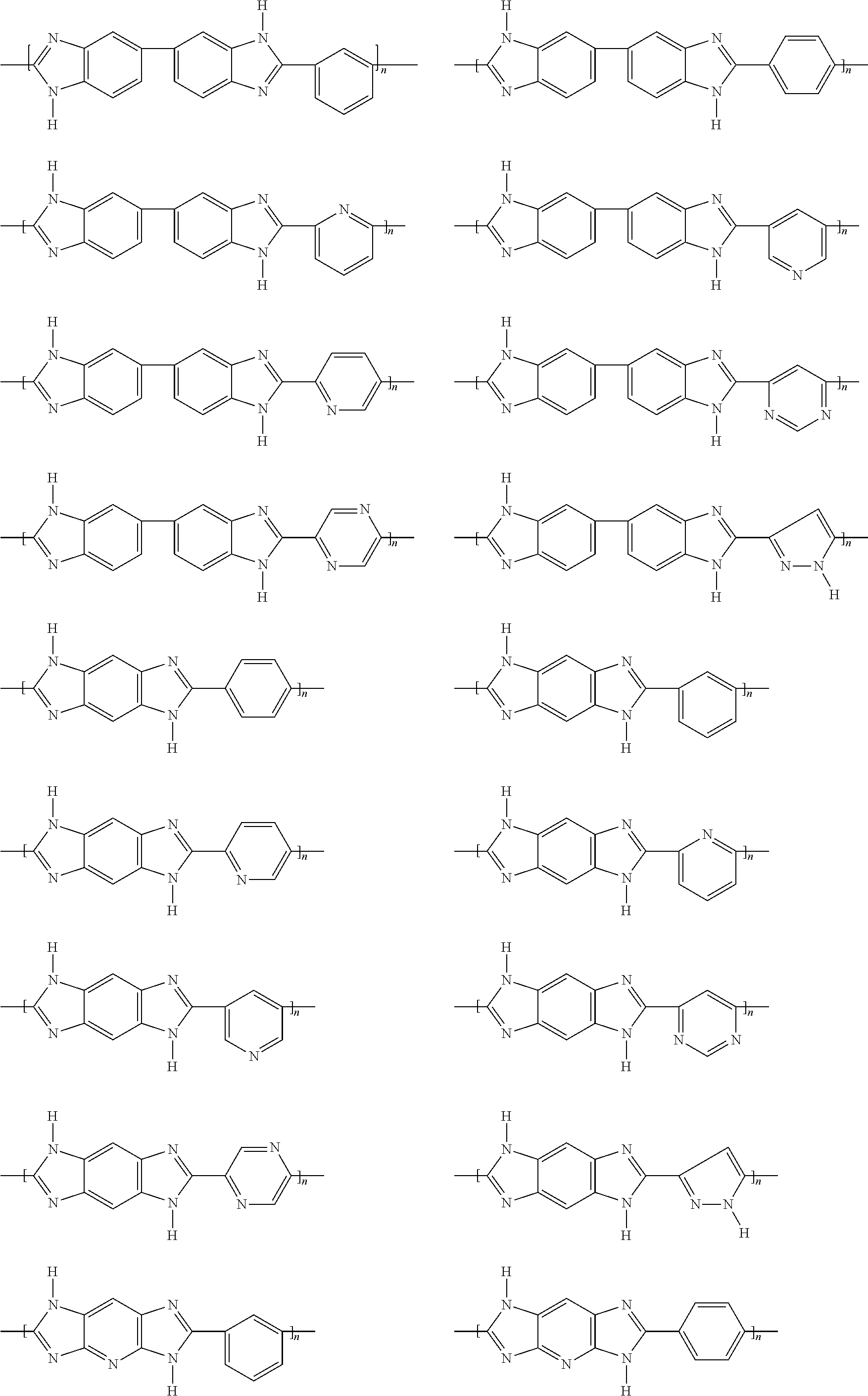

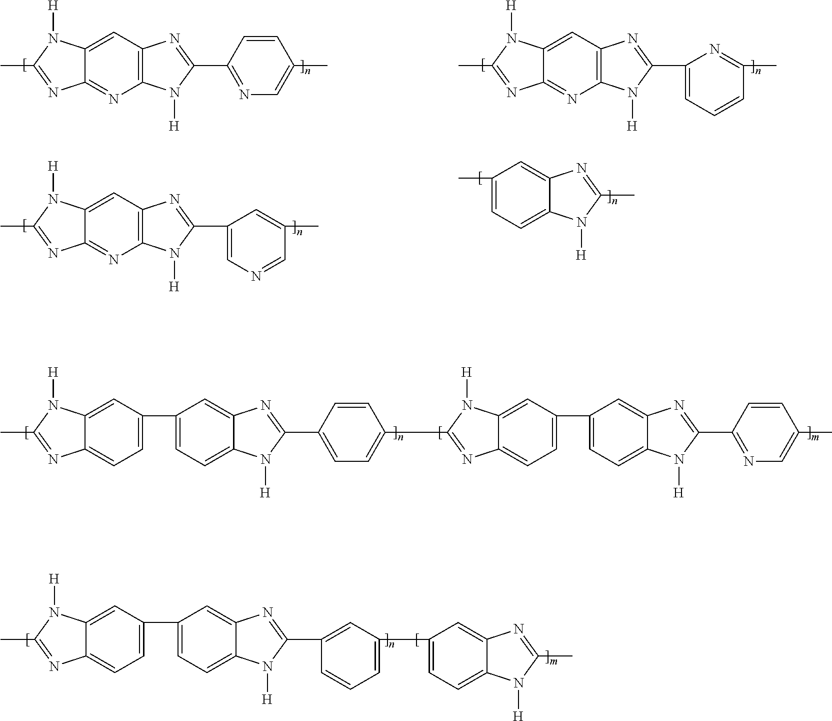

where n and m are each integers greater than or equal to 10, preferably greater than or equal to 100.

The polyazoles used, but especially the polybenzimidazoles, are notable for a high molecular weight. Measured as the intrinsic viscosity, it is at least 0.2 dl/g, preferably 0.8 to 10 dl/g, especially 1 to 10 dl/g.

The preparation of such polyazoles is known, one or more aromatic tetramino compounds being reacted with one or more aromatic carboxylic acids or esters thereof which comprise at least two acid groups per carboxylic acid monomer in the melt to give a prepolymer. The resulting prepolymer solidifies in the reactor and is then mechanically comminuted. The pulverulent prepolymer is typically finally polymerized in a solid phase polymerization at temperatures of up to 400° C.

The preferred aromatic carboxylic acids include dicarboxylic acids and tricarboxylic acids and tetracarboxylic acids, or esters thereof or anhydrides thereof or acid chlorides thereof. The term “aromatic carboxylic acids” likewise also comprises heteroaromatic carboxylic acids.

The aromatic dicarboxylic acids are preferably isophthalic acid, terephthalic acid, phthalic acid, 5-hydroxyisophthalic acid, 4-hydroxyisophthalic acid, 2-hydroxyterephthalic acid, 5-aminoisophthalic acid, 5-N,N-dimethylaminoisophthalic acid, 5-N,N-diethylaminoisophthalic acid, 2,5-dihydroxyterephthalic acid, 2,6-dihydroxyisophthalic acid, 4,6-dihydroxyisophthalic acid, 2,3-dihydroxyphthalic acid, 2,4-dihydroxyphthalic acid, 3,4-dihydroxyphthalic acid, 3-fluorophthalic acid, 5-fluoroisophthalic acid, 2-fluoroterephthalic acid, tetrafluorophthalic acid, tetrafluoroisophthalic acid, tetrafluoroterephthalic acid, 1,4-naphthalenedicarboxylic acid, 1,5-naphthalenedicarboxylic acid, 2,6-naphthalenedicarboxylic acid, 2,7-naphthalenedicarboxylic acid, diphenic acid, 1,8-dihydroxynaphthalene-3,6-dicarboxylic acid, diphenyl ether 4,4′-dicarboxylic acid, benzophenone-4,4′-dicarboxylic acid, diphenyl sulfone 4,4′-dicarboxylic acid, biphenyl-4,4′-dicarboxylic acid, 4-trifluoromethylphthalic acid, 2,2-bis(4-carboxyphenyl)hexafluoropropane, 4,4′-stilbenedicarboxylic acid and 4-carboxycinnamic acid, or the C1-C20-alkyl esters or C5-C12-aryl esters thereof or the acid anhydrides thereof or the acid chlorides thereof.

The aromatic tri-, tetracarboxylic acids or the C1-C20-alkyl esters or C5-C12-aryl esters thereof or the acid anhydrides thereof or the acid chlorides thereof are preferably 1,3,5-benzenetricarboxylic acid (trimesic acid), 1,2,4-benzenetricarboxylic acid (trimellitic acid), (2-carboxyphenyl)iminodiacetic acid, 3,5,3′-biphenyltricarboxylic acid or 3,5,4′-biphenyltricarboxylic acid.

The aromatic tetracarboxylic acids or the C1-C20-alkyl esters or C5-C12-aryl esters thereof or the acid anhydrides thereof or the acid chlorides thereof are preferably 3,5,3′,5′-biphenyltetracarboxylic acid, 1,2,4,5-benzenetetracarboxylic acid, benzophenonetetracarboxylic acid, 3,3′,4,4′-biphenyltetracarboxylic acid, 2,2′,3,3′-biphenyltetracarboxylic acid, 1,2,5,6-naphthalenetetracarboxylic acid or 1,4,5,8-naphthalenetetracarboxylic acid.

The heteroaromatic carboxylic acids used are preferably heteroaromatic dicarboxylic acids, tricarboxylic acids and tetracarboxylic acids, or the esters thereof or the anhydrides thereof. Heteroaromatic carboxylic acids are understood to mean aromatic systems which contain at least one nitrogen, oxygen, sulfur or phosphorus atom in the aromatic ring. They are preferably pyridine-2,5-dicarboxylic acid, pyridine-3,5-dicarboxylic acid, pyridine-2,6-dicarboxylic acid, pyridine-2,4-dicarboxylic acid, 4-phenyl-2,5-pyridinedicarboxylic acid, 3,5-pyrazoledicarboxylic acid, 2,6-pyrimidinedicarboxylic acid, 2,5-pyrazinedicarboxylic acid, 2,4,6-pyridinetricarboxylic acid or benzimidazole-5,6-dicarboxylic acid, and the C1-C20-alkyl esters or C5-C12-aryl esters thereof, or the acid anhydrides thereof or the acid chlorides thereof.

The content of tricarboxylic acid or tetracarboxylic acid (based on the dicarboxylic acid used) is between 0 and 30 mol %, preferably 0.1 and 20 mol %, especially 0.5 and 10 mol %.

The aromatic and heteroaromatic diaminocarboxylic acids used are preferably diaminobenzoic acid or the mono- and dihydrochloride derivatives thereof.

Preferably, mixtures of at least 2 different aromatic carboxylic acids are to be used. Particular preference is given to using mixtures which comprise, as well as aromatic carboxylic acids, also heteroaromatic carboxylic acids. The mixing ratio of aromatic carboxylic acids to heteroaromatic carboxylic acids is between 1:99 and 99:1, preferably 1:50 to 50:1.

These mixtures are especially mixtures of N-heteroaromatic dicarboxylic acids and aromatic dicarboxylic acids. Nonlimiting examples thereof are isophthalic acid, terephthalic acid, phthalic acid, 2,5-dihydroxyterephthalic acid, 2,6-dihydroxyisophthalic acid, 4,6-dihydroxyisophthalic acid, 2,3-dihydroxyphthalic acid, 2,4-dihydroxyphthalic acid, 3,4-dihydroxyphthalic acid, 1,4-naphthalenedicarboxylic acid, 1,5-naphthalenedicarboxylic acid, 2,6-naphthalenedicarboxylic acid, 2,7-naphthalenedicarboxylic acid, diphenic acid, 1,8-dihydroxynaphthalene-3,6-dicarboxylic acid, diphenyl ether 4,4′-dicarboxylic acid, benzophenone-4,4′-dicarboxylic acid, diphenyl sulfone 4,4′-dicarboxylic acid, biphenyl-4,4′-dicarboxylic acid, 4-trifluoromethylphthalic acid, pyridine-2,5-dicarboxylic acid, pyridine-3,5-dicarboxylic acid, pyridine-2,6-dicarboxylic acid, pyridine-2,4-dicarboxylic acid, 4-phenyl-2,5-pyridinedicarboxylic acid, 3,5-pyrazoledicarboxylic acid, 2,6-pyrimidinedicarboxylic acid, 2,5-pyrazinedicarboxylic acid.

The preferred aromatic tetramino compounds include 3,3′,4,4′-tetraaminobiphenyl, 2,3,5,6-tetraaminopyridine, 1,2,4,5-tetraaminobenzene, 3,3′,4,4′-tetraminodiphenyl sulfone, 3,3′,4,4′-tetraaminodiphenyl ether, 3,3′,4,4′-tetraaminobenzophenone, 3,3′,4,4′-tetraaminodiphenylmethane and 3,3′,4,4′-tetraaminodiphenyldimethylmethane and salts thereof, especially the mono-, di-, tri- and tetrahydrochloride derivatives thereof.

Preferred polybenzimidazoles are commercially available under the Celazole® trade name.

The preferred polymers include polysulfones, more particularly polysulfone with aromatic and/or heteroaromatic groups in the main chain. In a particular aspect of the present invention, preferred polysulfones and polyether sulfones have a melt volume flow rate MVR 300/21.6 less than or equal to 40 cm³/10 min, especially less than or equal to 30 cm³/10 min and more preferably less than or equal to 20 cm³/10 min, measured to ISO 1133. Preference is given here to polysulfones having a Vicat softening temperature VST/A/50 of 180° C. to 230° C. In another preferred embodiment of the present invention, the number-average molecular weight of the polysulfones is greater than 30 000 g/mol.

The polymers based on polysulfone include especially polymers which have repeat units with linking sulfone groups according to the general formulae A, B, C, D, E, F and/or G:

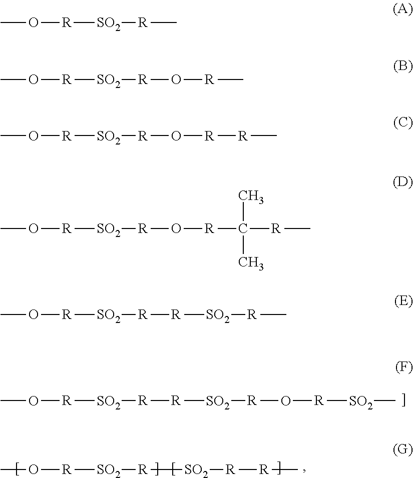

in which the R radicals are the same or different and are each independently an aromatic or heteroaromatic group, these radicals having been elucidated in detail above. These include especially 1,2-phenylene, 1,3-phenylene, 1,4-phenylene, 4,4′-biphenyl, pyridine, quinoline, naphthalene, phenanthrene.

The polysulfones preferred in the context of the present invention include homo- and copolymers, for example random copolymers. Particularly preferred polysulfones comprise repeat units of the formulae H to N:

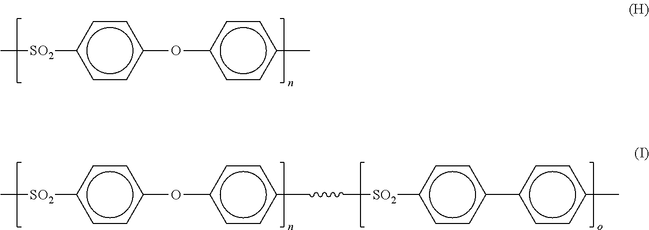

where n>o

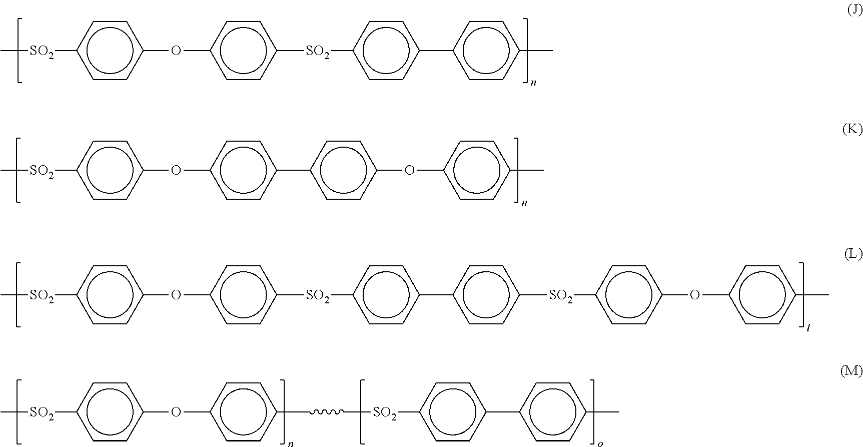

where n<o

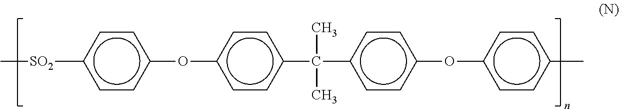

The above-described polysulfones can be obtained commercially under the ®Victrex 200 P, ®Victrex 720 P, ®Ultrason E, ®Ultrason S, ®Mindel, ®Radel A, ®Radel R, ®Victrex HTA, ®Astrel and ®Udel trade names.

In addition, particular preference is given to polyether ketones, polyether ketone ketones, polyether ether ketones, polyether ether ketone ketones and polyaryl ketones. These high-performance polymers are known per se and can be obtained commercially under the Victrex® PEEK™, ®Hostatec, ®Kadel trade names.

The aforementioned polysulfones and said polyether ketones, polyether ketone ketones, polyether ether ketones, polyether ether ketone ketones and polyaryl ketones may, as already stated, be present as a blend constituent with basic polymers. In addition, the aforementioned polysulfones and the aforementioned polyether ketones, polyether ketone ketones, polyether ether ketones, polyether ether ketone ketones and polyaryl ketones can be used in sulfonated form as a polymer electrolyte, in which case the sulfonated materials may also comprise basic polymers, especially polyazoles as blend material. For these embodiments too, the disclosed and preferred embodiments with regard to the basic polymers or polyazoles apply.

To produce polymer films, a polymer, preferably a basic polymer, especially a polyazole, can be dissolved in a further step in polar aprotic solvents, for example dimethylacetamide (DMAc), and a film can be produced by means of conventional processes.

To remove solvent residues, the film thus obtained can be treated with a wash liquid, as described in WO 02/071518. The cleaning of the polyazole film to remove solvent residues, described in the German patent application, surprisingly improves the mechanical properties of the film. These properties comprise especially the modulus of elasticity, the breaking strength and the fracture toughness of the film.

In addition, the polymer film may have further modifications, for example by crosslinking, as described in WO 02/070592 or in WO 00/44816. In a preferred embodiment, the polymer film used, composed of a basic polymer and at least one blend component, additionally comprises a crosslinker as described in WO 03/016384.

The thickness of the polyazole films may be within wide ranges. The thickness of the polyazole film before doping with acid is preferably within the range from 5 μm to 2000 μm, more preferably within the range from 10 μm to 1000 μm, without any intention that this should impose a restriction.

In order to achieve proton conductivity, these films are doped with an acid. Acids in this context comprise all known Lewis and Brønsted acids, preferably inorganic Lewis and Brønsted acids.

In addition, it is also possible to use polyacids, especially isopolyacids and heteropolyacids, and also mixtures of different acids. In the context of the present invention, heteropolyacids refer to inorganic polyacids having at least two different central atoms, which form from polybasic oxygen acids, each of them weak acids, of a metal (preferably Cr, Mo, V, W) and a nonmetal (preferably As, I, P, Se, Si, Te) in the form of partial mixed anhydrides. These include 12-molybdato-phosphoric acid and 12-tungstophosphoric acid.

The conductivity of the polyazole film can be influenced via the level of doping. The conductivity increases with rising dopant concentration until a maximum value is attained. According to the invention, the level of doping is reported as moles of acid per mole of repeat unit of the polymer. In the context of the present invention, preference is given to a doping level between 3 and 50, especially between 5 and 40.

Particularly preferred dopants are sulfuric acid and phosphoric acid, or compounds which release these acids, for example under hydrolysis or due to the temperature. A very particularly preferred dopant is phosphoric acid (H₃PO₄). In this case, generally highly concentrated acids are used. In a particular aspect of the present invention, the concentration of the phosphoric acid is at least 50% by weight, especially at least 80% by weight, based on the weight of the dopant.

In addition, it is also possible to obtain proton-conductive membranes by a process comprising the steps of
I) dissolving polymers, especially polyazoles in polyphosphoric acid,
II) heating the solution obtainable in step A) under inert gas to temperatures of up to 400° C.,
III) forming a membrane using the solution of the polymer according to step II) on a support and
IV) treating the membrane formed in step III) until it is self-supporting.

In addition, doped polyazole films can be obtained by a process comprising the steps of
A) mixing one or more aromatic tetramino compounds with one or more aromatic carboxylic acids or esters thereof which comprise at least two acid groups per carboxylic acid monomer, or mixing one or more aromatic and/or heteroaromatic diaminocarboxylic acids, in polyphosphoric acid to form a solution and/or dispersion
B) applying a layer using the mixture according to step A) on a support or on an electrode,
C) heating the flat structure/layer obtainable according to step B) under inert gas to temperatures of up to 350° C., preferably up to 280° C., to form the polyazole polymer,
D) treating the membrane formed in step C) (until it is self-supporting).

The aromatic or heteroaromatic carboxylic acid and tetramino compounds to be used in step A) have been described above.

The polyphosphoric acid used in step A) comprises commercial polyphosphoric acids, as obtainable, for example, from Riedel-de Haen. The polyphosphoric acids Hₙ₊₂PₙO₃ₙ₊₁ (n>1) typically have a content, calculated as P₂O₅ (by acidimetric means), of at least 83%. Instead of a solution of the monomers, it is also possible to produce a dispersion/suspension.

The mixture obtained in step A) has a weight ratio of polyphosphoric acid to sum of all monomers of 1:10 000 to 10 000:1, preferably 1:1000 to 1000:1, especially 1:100 to 100:1.

The layer formation in step B) is effected by means of measures known per se (casting, spraying, knife-coating) which are known from the prior art for polymer film production. Suitable supports are all supports which can be described as inert under the conditions. To adjust the viscosity, the solution can optionally be admixed with phosphoric acid (conc. phosphoric acid, 85%). This can adjust the viscosity to the desired value and facilitate the formation of the membrane.

The layer produced in step B) has a thickness between 20 and 4000 μm, preferably between 30 and 3500 μm, especially between 50 and 3000 μm.

If the mixture according to step A) also comprises tricarboxylic acids or tetracarboxylic acids, this achieves branching/crosslinking of the polymer formed.

This contributes to an improvement in the mechanical properties. The polymer layer produced in step C) is treated in the presence of moisture at temperatures and for durations sufficient for the layer to have sufficient strength for use in fuel cells. The treatment can be effected to such an extent that the membrane is self-supporting, such that it can be detached from the support without damage.

In step C), the flat structure obtained in step B) is heated to a temperature of up to 350° C., preferably up to 280° C. and more preferably in the range from 200° C. to 250° C. The inert gases for use in step C) are known in the technical field. These include especially nitrogen and noble gases, such as neon, argon, helium.

In one variant of the process, heating the mixture from step A) to temperatures of up to 350° C., preferably up to 280° C., can already bring about the formation of oligomers and/or polymers. Depending on the temperature and duration selected, it is subsequently possible to partly or entirely dispense with the heating in step C). This variant too forms part of the subject matter of the present invention.

The membrane is treated in step D) at temperatures above 0° C. and less than 150° C., preferably at temperatures between 10° C. and 120° C., especially between room temperature (20° C.) and 90° C., in the presence of moisture or water and/or water vapor and/or water-containing phosphoric acid of up to 85%. The treatment is preferably effected under standard pressure, but can also be effected under pressure. What is essential is that the treatment takes place in the presence of sufficient moisture, as a result of which the polyphosphoric acid present contributes to the consolidation of the membrane by partial hydrolysis to form low molecular weight polyphosphoric acid and/or phosphoric acid.

The hydrolysis liquid may be a solution, in which case the liquid may also comprise suspended and/or dispersed constituents. The viscosity of the hydrolysis liquid may be within wide ranges, and the viscosity can be adjusted by adding solvents or increasing the temperature. The dynamic viscosity is preferably in the range from 0.1 to 10 000 mPa*s, especially 0.2 to 2000 mPa*s, and these values can be measured, for example, to DIN 53015.

The treatment in step D) can be effected by any known method. For example, the membrane obtained in step C) can be immersed into a liquid bath. In addition, the hydrolysis liquid can be sprayed onto the membrane. Moreover, the hydrolysis liquid can be poured over the membrane. The latter methods have the advantage that the concentration of acid in the hydrolysis liquid remains constant during the hydrolysis. However, the first process is frequently less expensive to execute.

The oxygen acids of phosphorus and/or sulfur include especially phosphinic acid, phosphonic acid, phosphoric acid, hypodiphosphonic acid, hypodiphosphoric acid, oligophosphoric acids, sulfurous acid, disulfurous acid and/or sulfuric acid. These acids can be used individually or as a mixture.

In addition, the oxygen acids of phosphorus and/or sulfur comprise free-radically polymerizable monomers comprising phosphonic acid and/or sulfonic acid groups.

Monomers comprising phosphonic acid groups are known in the specialist field. These are compounds which have at least one carbon-carbon double bond and at least one phosphonic acid group. The two carbon atoms which form carbon-carbon double bonds preferably have at least two, preferably 3, bonds to groups which lead to low steric hindrance of the double bond. These groups include hydrogen atoms and halogen atoms, especially fluorine atoms. In the context of the present invention, the polymer comprising phosphonic acid groups results from the polymerization product which is obtained by polymerization of the monomer comprising phosphonic acid groups alone or with further monomers and/or crosslinkers.

The monomer comprising phosphonic acid groups may comprise one, two, three or more carbon-carbon double bonds. In addition, the monomer comprising phosphonic acid groups may comprise one, two, three or more phosphonic acid groups.

In general, the monomer comprising phosphonic acid groups comprises 2 to 20, preferably 2 to 10, carbon atoms.

The monomer comprising phosphonic acid groups preferably comprises compounds of the formula

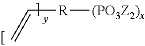

in which
R is a bond, a divalent C1-C15-alkylene group, divalent C1-C15-alkyleneoxy group, for example ethyleneoxy group, or divalent C5-C20-aryl or heteroaryl group, where the above radicals may in turn be substituted by halogen, —OH, COOZ, —CN, NZ₂,
Z is independently hydrogen, C1-C15-alkyl group, C1-C15-alkoxy group, ethyleneoxy group or C5-C20-aryl or heteroaryl group, where the above radicals may in turn be substituted by halogen, —OH, —CN, and
x is an integer of 1, 2, 3, 4, 5, 6, 7, 8, 9 or 10
y is an integer of 1, 2, 3, 4, 5, 6, 7, 8, 9 or 10
   and/or of the formula

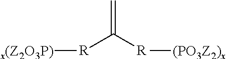

in which
R is a bond, a divalent C1-C15-alkylene group, divalent C1-C15-alkyleneoxy group, for example ethyleneoxy group, or divalent C5-C20-aryl or heteroaryl group, where the above radicals may in turn be substituted by halogen, —OH, COOZ, —CN, NZ₂,
Z is independently hydrogen, C1-C15-alkyl group, C1-C15-alkoxy group, ethyleneoxy group or C5-C20-aryl or heteroaryl group, where the above radicals may in turn be substituted by halogen, —OH, —CN, and
x is an integer of 1, 2, 3, 4, 5, 6, 7, 8, 9 or 10
   and/or of the formula

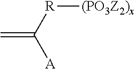

in which
A is a group of the formulae COOR², CN, CONR²₂, OR² and/or R², in which R² is hydrogen, a C1-C15-alkyl group, C1-C15-alkoxy group, ethyleneoxy group or C5-C20-aryl or heteroaryl group, where the above radicals may in turn be substituted by halogen, —OH, COOZ, —CN, NZ₂
R is a bond, a divalent C1-C15-alkylene group, divalent C1-C15-alkyleneoxy group, for example ethyleneoxy group, or divalent C5-C20-aryl or heteroaryl group, where the above radicals may in turn be substituted by halogen, —OH, COOZ, —CN, NZ₂,
Z is independently hydrogen, C1-C15-alkyl group, C1-C15-alkoxy group, ethyleneoxy group or C5-C20-aryl or heteroaryl group, where the above radicals may in turn be substituted by halogen, —OH, —CN, and
x is an integer of 1, 2, 3, 4, 5, 6, 7, 8, 9 or 10.

The preferred monomers comprising phosphonic acid groups include alkenes having phosphonic acid groups, such as ethenephosphonic acid, propenephosphonic acid, butenephosphonic acid; acrylic acid compounds and/or methacrylic acid compounds having phosphonic acid groups, for example 2-phosphonomethylacrylic acid, 2-phosphonomethylmethacrylic acid, 2-phosphonomethylacrylamide and 2-phosphonomethylmethacrylamide.

Particular preference is given to using commercial vinylphosphonic acid, (ethenephosphonic acid), as obtainable, for example, from Aldrich or Clariant GmbH. A preferred vinylphosphonic acid has a purity of more than 70%, especially 90%, and more preferably more than 97%.

The monomers comprising phosphonic acid groups can additionally also be used in the form of derivatives which can subsequently be converted to the acid, and this conversion to the acid can also be effected in the polymerized state. These derivatives include especially the salts, the esters, the amides and the halides of the monomers comprising phosphonic acid groups.

The monomers comprising phosphonic acid groups can additionally also be introduced onto and into the membrane after the hydrolysis. This can be done by means of measures known per se (for example spraying, dipping, etc.), which are known from the prior art.

In a particular aspect of the present invention, the ratio of the weight of the sum of phosphoric acid, polyphosphoric acid and the hydrolysis products of polyphosphoric acid to the weight of the free-radically polymerizable monomers, for example of the monomers comprising phosphonic acid groups, is preferably greater than or equal to 1:2, especially greater than or equal to 1:1 and more preferably greater than or equal to 2:1.

The ratio of the weight of the sum of phosphoric acid, polyphosphoric acid and the hydrolysis products of polyphosphoric acid to the weight of the free-radically polymerizable monomers is in the range from 1000:1 to 3:1, especially 100:1 to 5:1 and more preferably 50:1 to 10:1.

This ratio can be determined easily by customary methods, it being possible in many cases to wash the phosphoric acid, polyphosphoric acid and hydrolysis products thereof out of the membrane. The basis used here may be the weight of the polyphosphoric acid and hydrolysis products thereof after complete hydrolysis to phosphoric acid. This is generally likewise the case for the free-radically polymerizable monomers.

Monomers comprising sulfonic acid groups are known in the technical field. These are compounds which have at least one carbon-carbon double bond and at least one sulfonic acid group. Preferably, the two carbon atoms which form the carbon-carbon double bonds have at least two, preferably 3, bonds to groups which lead to low steric hindrance of the double bond. These groups include hydrogen atoms and halogen atoms, especially fluorine atoms. In the context of the present invention, the polymer comprising sulfonic acid groups results from the polymerization product which is obtained by polymerization of the monomer comprising sulfonic acid groups alone or with further monomers and/or crosslinkers.

The monomer comprising sulfonic acid groups may comprise one, two, three or more carbon-carbon double bonds. In addition, the monomer comprising sulfonic acid groups may comprise one, two, three or more sulfonic acid groups.

In general, the monomer comprising sulfonic acid groups comprises 2 to 20 and preferably 2 to 10 carbon atoms.

The monomer comprising sulfonic acid groups is preferably a compound of the formula

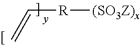

in which
R is a bond, a divalent C1-C15-alkylene group, divalent C1-C15-alkyleneoxy group, for example ethyleneoxy group, or divalent C5-C20-aryl or heteroaryl group, where the above radicals may in turn be substituted by halogen, —OH, COOZ, —CN, NZ₂,
Z is independently hydrogen, C1-C15-alkyl group, C1-C15-alkoxy group, ethyleneoxy group or C5-C20-aryl or heteroaryl group, where the above radicals may in turn be substituted by halogen, —OH, —CN, and
x is an integer of 1, 2, 3, 4, 5, 6, 7, 8, 9 or 10
y is an integer of 1, 2, 3, 4, 5, 6, 7, 8, 9 or 10
   and/or of the formula

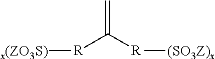

in which
R is a bond, a divalent C1-C15-alkylene group, divalent C1-C15-alkyleneoxy group, for example ethyleneoxy group, or divalent C5-C20-aryl or heteroaryl group, where the above radicals may in turn be substituted by halogen, —OH, COOZ, —CN, NZ₂,
Z is independently hydrogen, C1-C15-alkyl group, C1-C15-alkoxy group, ethyleneoxy group or C5-C20-aryl or heteroaryl group, where the above radicals may in turn be substituted by halogen, —OH, —CN, and
x is an integer of 1, 2, 3, 4, 5, 6, 7, 8, 9 or 10
   and/or of the formula

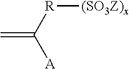

in which
A is a group of the formulae COOR², CN, CONR²₂, OR² and/or R², in which R² is hydrogen, a C1-C15-alkyl group, C1-C15-alkoxy group, ethyleneoxy group or C5-C20-aryl or heteroaryl group, where the above radicals may in turn be substituted by halogen, —OH, COOZ, —CN, NZ₂
R is a bond, a divalent C1-C15-alkylene group, divalent C1-C15-alkyleneoxy group, for example ethyleneoxy group, or divalent C5-C20-aryl or heteroaryl group, where the above radicals may in turn be substituted by halogen, —OH, COOZ, —CN, NZ₂,
Z is independently hydrogen, C1-C15-alkyl group, C1-C15-alkoxy group, ethyleneoxy group or C5-C20-aryl or heteroaryl group, where the above radicals may in turn be substituted by halogen, —OH, —CN, and
x is an integer of 1, 2, 3, 4, 5, 6, 7, 8, 9 or 10.

The preferred monomers comprising sulfonic acid groups include alkenes which have sulfonic acid groups, such as ethenesulfonic acid, propenesulfonic acid, butenesulfonic acid; acrylic acid compounds and/or methacrylic acid compounds having sulfonic acid groups, for example 2-sulfomethylacrylic acid, 2-sulfo-methylmethacrylic acid, 2-sulfomethylacrylamide and 2-sulfo-methylmethacrylamide.

Particular preference is given to using commercial vinylsulfonic acid (ethenesulfonic acid), as obtainable, for example, from Aldrich or Clariant GmbH. A preferred vinylsulfonic acid has a purity of more than 70%, especially 90%, and more preferably more than 97% purity.

The monomers comprising sulfonic acid groups can additionally also be used in the form of derivatives which can subsequently be converted to the acid, and this conversion to the acid can also be effected in the polymerized state. These derivatives include especially the salts, the esters, the amides and the halides of the monomers comprising sulfonic acid groups.

The monomers comprising sulfonic acid groups can additionally also be introduced onto and into the membrane after the hydrolysis. This can be done by means of measures known per se (for example spraying, dipping, etc.), which are known from the prior art.

In a further embodiment of the invention, monomers capable of crosslinking can be used. These monomers can be added to the hydrolysis liquid. In addition, the monomers capable of crosslinking can also be applied to the membrane obtained after the hydrolysis.

The monomers capable of crosslinking are especially compounds which have at least 2 carbon-carbon double bonds. Preference is given to dienes, trienes, tetraenes, dimethyl acrylates, trimethyl acrylates, tetramethyl acrylates, diacrylates, triacrylates, tetraacrylates.

Particular preference is given to dienes, trienes, tetraenes of the formula

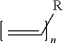

dimethyl acrylates, trimethyl acrylates, tetramethyl acrylates of the formula

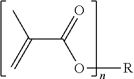

diacrylates, triacrylates, tetraacrylates of the formula

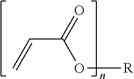

in which
R is a C1-C15-alkyl group, C5-C20-aryl or heteroaryl group, NR′, —SO₂, PR′, Si(R′)₂, where the above radicals in turn may be substituted,
R′ is independently hydrogen, a C1-C15-alkyl group, C1-C15-alkoxy group, C5-C20-aryl or heteroaryl group and
n is at least 2.
   The substituents of the above R radical are preferably halogen, hydroxyl, carboxy, carboxyl, carboxyl ester, nitrile, amine, silyl, siloxane radicals.

Particularly preferred crosslinkers are allyl methacrylate, ethylene glycol dimethacrylate, diethylene glycol dimethacrylate, triethylene glycol dimethacrylate, tetra- and polyethylene glycol dimethacrylate, 1,3-butanediol dimethacrylate, glyceryl dimethacrylate, diurethane dimethacrylate, trimethylpropane trimethacrylate, epoxy acrylates, for example Ebacryl, N′,N-methylenebisacrylamide, carbinol, butadiene, isoprene, chloroprene, divinylbenzene and/or bisphenol-A dimethyl acrylate. These compounds are commercially available, for example, from Sartomer Company Exton, Pennsylvania under the designations CN-120, CN104 and CN-980.

The use of crosslinkers is optional, and these compounds can be used typically in the range between 0.05 to 30% by weight, preferably 0.1 to 20% by weight, more preferably 1 and 10% by weight, based on the weight of the membrane.

The crosslinking monomers can be introduced onto and into the membrane after the hydrolysis. This can be done by means of measures known per se (for example spraying, dipping etc.), which are known from the prior art.

In a particular aspect of the present invention, the monomers comprising phosphonic acid and/or sulfonic acid groups and the crosslinking monomers can be polymerized, the polymerization preferably being effected by free-radical means. The free radicals can be formed thermally, photochemically, chemically and/or electrochemically.

For example, an initiator solution which comprises at least one substance capable of forming free radicals can be added to the hydrolysis liquid. In addition, an initiator solution be applied to the membrane after the hydrolysis. This can be done by means of measures known per se (for example dipping, spraying, etc.), which are known from the prior art.

Suitable free-radical initiators include azo compounds, peroxy compounds, persulfate compounds or azoamidines. Nonlimiting examples are dibenzoyl peroxide, dicumene peroxide, cumene hydroperoxide, diisopropyl peroxodicarbonate, bis(4-t-butylcyclohexyl) peroxodicarbonate, dipotassium persulfate, ammonium peroxodisulfate, 2,2′-azobis(2-methylpropionitrile) (AIBN), 2,2′-azobis(isobutyramidine) hydrochloride, benzpinacol, dibenzyl derivatives, methyl ethylene ketone peroxide, 1,1-azobiscyclohexanecarbonitrile, methyl ethyl ketone peroxide, acetylacetone peroxide, dilauryl peroxide, didecanoyl peroxide, tert-butyl per-2-ethylhexanoate, ketone peroxide, methyl isobutyl ketone peroxide, cyclohexanone peroxide, dibenzoyl peroxide, tert-butyl peroxybenzoate, tert-butyl peroxyisopropylcarbonate, 2,5-bis(2-ethylhexanoylperoxy)-2,5-dimethylhexane, tert-butyl peroxy-2-ethylhexanoate, tert-butyl peroxy-3,5,5-trimethylhexanoate, tert-butyl peroxyisobutyrate, tert-butyl peroxyacetate, dicumyl peroxide, 1,1-bis(tert-butylperoxy)cyclohexane, 1,1-bis(tert-butylperoxy)-3,3,5-trimethylcyclohexane, cumyl hydroperoxide, tert-butyl hydroperoxide, bis(4-tert-butylcyclohexyl) peroxydicarbonate, and the free-radical initiators obtainable from DuPont under the ®Vazo name, for example ®Vazo V50 and ®Vazo WS.

In addition, it is also possible to use free-radical initiators which form free radicals under irradiation. Preferred compounds include □□□-diethoxyacetophenone (DEAP, Upjohn Corp), n-butyl benzoin ether (®Trigonal-14, AKZO) and 2,2-dimethoxy-2-phenylacetophenone (®Irgacure 651) and 1-benzoylcyclohexanol (®Irgacure 184), bis(2,4,6-trimethylbenzoyl)phenylphosphine oxide (®Irgacure 819) and 1-[4-(2-hydroxyethoxy)phenyl]-2-hydroxy-2-phenylpropan-1-one (®Irgacure 2959), each of which is commercially available from Ciba Geigy Corp.

Typically between 0.0001 and 5% by weight, especially 0.01 and 3% by weight (based on the weight of the free-radically polymerizable monomers; monomers comprising phosphonic acid and/or sulfonic acid groups and/or the crosslinking monomers) of free-radical initiator is added. The amount of free-radical initiator can be varied according to the desired degree of polymerization.

The polymerization can also be effected by the action of IR or NIR (IR=infrared, i.e. light with a wavelength of more than 700 nm; NIR=near IR, i.e. light with a wavelength in the range from approx. 700 to 2000 nm or an energy in the range from approx. 0.6 to 1.75 eV).

The polymerization can also be effected by the action of UV light with a wavelength of less than 400 nm. This polymerization method is known per se and is described, for example, in Hans Joerg Elias, Makromolekulare Chemie [Macromolecular Chemistry], 5th edition, volume 1, p. 492-511; D. R. Arnold, N. C. Baird, J. R. Bolton, J. C. D. Brand, P. W. M Jacobs, P. de Mayo, W. R. Ware, Photochemistry—An Introduction, Academic Press, New York and M. K. Mishra, Radical Photopolymerization of Vinyl Monomers, J. Macromol. Sci.-Revs. Macromol. Chem. Phys. C22 (1982-1983) 409.

The polymerization can also be achieved by the action of β rays, γ rays and/or electron beams. In a particular embodiment of the present invention, a membrane is irradiated with a radiation dose in the range from 1 to 300 kGy, preferably from 3 to 200 kGy and most preferably from 20 to 100 kGy.

The polymerization of the monomers comprising phosphonic acid and/or sulfonic acid groups and/or the crosslinking monomers is effected preferably at temperatures above room temperature (20° C.) and less than 200° C., especially at temperatures between 40° C. and 150° C., more preferably between 50° C. and 120° C. The polymerization is effected preferably under standard pressure, but can also be effected under the action of pressure. The polymerization leads to solidification of the flat structure, and this solidification can be monitored by microhardness measurement. The increase in the hardness caused by the polymerization is preferably at least 20%, based on the hardness of a correspondingly hydrolyzed membrane without polymerization of the monomers.

In a particular aspect of the present invention, the molar ratio of the molar sum of phosphoric acid, polyphosphoric acid and the hydrolysis products of polyphosphoric acid to the number of moles of phosphonic acid groups and/or sulfonic acid groups in the polymers obtainable by polymerization of monomers comprising phosphonic acid groups and/or monomers comprising sulfonic acid groups is preferably greater than or equal to 1:2, especially greater than or equal to 1:1 and more preferably greater than or equal to 2:1.

The molar ratio of the molar sum of phosphoric acid, polyphosphoric acid and the hydrolysis products of polyphosphoric acid to the number of moles of phosphonic acid groups and/or sulfonic acid groups in the polymers obtainable by polymerization of monomers comprising phosphonic acid groups and/or monomers comprising sulfonic acid groups is preferably in the range from 1000:1 to 3:1, especially 100:1 to 5:1 and more preferably 50:1 to 10:1.

The molar ratio can be determined by customary methods. For this purpose, it is possible to use especially spectroscopic methods, for example NMR spectroscopy. In this context, it should be remembered that the phosphonic acid groups are present in the formal oxidation state of 3, and the phosphorus in phosphoric acid, polyphosphoric acid or hydrolysis products thereof in the oxidation state of 5.

According to the desired degree of polymerization, the flat structure which is obtained after the polymerization is a self-supporting membrane. The degree of polymerization is preferably at least 2, especially at least 5 and more preferably at least 30 repeat units, especially at least 50 repeat units and most preferably at least 100 repeat units. This degree of polymerization is determined via the number-average molecular weight Mₙ, which can be determined by GPC methods. Due to the problems with isolating the polymers which comprise phosphonic acid groups and are present in the membrane without degradation, this value is determined using a sample which is conducted by polymerization of monomers comprising phosphonic acid groups without addition of polymer. In this case, the proportion by weight of monomers comprising phosphonic acid groups and of free-radical initiator is kept constant compared to the conditions of production of the membrane. The conversion which is achieved in a comparative polymerization is preferably greater than or equal to 20%, especially greater than or equal to 40% and more preferably greater than or equal to 75%, based on the monomers comprising phosphonic acid groups used.

The hydrolysis liquid comprises water, the concentration of water generally not being particularly critical. In a particular aspect of the present invention, the hydrolysis liquid comprises 5 to 80% by weight, preferably 8 to 70% by weight and more preferably 10 to 50% by weight of water. The amount of water present in the oxygen acids in a formal sense is not taken into account for the water content of the hydrolysis liquid.

Among the aforementioned acids, phosphoric acid and/or sulfuric acid are particularly preferred, these acids comprising especially 5 to 70% by weight, preferably 10 to 60% by weight and more preferably 15 to 50% by weight of water.

The at least partial hydrolysis of the polyphosphoric acid in step D) leads to a solidification of the membrane due to a sol/gel transition. Also associated with this is a decrease in the layer thickness to from 15 to 3000 μm, preferably between 20 and 2000 μm, especially between 20 and 1500 μm; the membrane is self-supporting.

The intra- and intermolecular structures (interpenetrating networks, IPN) present in the polyphosphoric acid layer according to step B) lead, in step C), to ordered membrane formation which is found to be responsible for the special properties of the membrane formed.

The upper temperature limit of the treatment according to step D) is generally 150° C. In the case of extremely brief action of moisture, for example of superheated steam, this vapor may also be hotter than 150° C. The essential factor for the upper temperature limit is the duration of the treatment.

The at least partial hydrolysis (step D) can also be effected in climate-controlled chambers in which the hydrolysis can be controlled under defined action of moisture. In this case, the moisture content can be adjusted in a controlled manner via the temperature or saturation of the contact environment, for example gases such as air, nitrogen, carbon dioxide or other suitable gases, or water vapor. The treatment time depends on the parameters selected above.

In addition, the treatment time depends on the membrane thicknesses.

In general, the treatment time is between a few seconds and minutes, for example under the action of superheated steam, or up to whole days, for example under air at room temperature and low relative air humidity. The treatment time is preferably between 10 seconds and 300 hours, especially 1 minute to 200 hours.

When the partial hydrolysis is performed at room temperature (20° C.) with ambient air of relative air humidity 40-80%, the treatment time is between 1 and 200 hours.

The membrane obtained according to step D) can be configured so as to be self-supporting, i.e. it can be detached without damage from the support and then optionally processed further directly.

It is possible to adjust the concentration of phosphoric acid and hence the conductivity of the polymer membrane via the degree of hydrolysis, i.e. the time, temperature and ambient humidity. The concentration of phosphoric acid is reported as moles of acid per mole of repeat unit of the polymer. The process comprising steps A) to D) can give membranes with a particularly high phosphoric acid concentration. Preference is given to a concentration (moles of phosphoric acid based on one repeat unit of the formula (I), for example polybenzimidazole) between 10 and 50, especially between 12 and 40. Such high degrees of doping (concentrations) are obtainable by doping of polyazoles with commercially available orthophosphoric acid only with very great difficulty, if at all.

In one variant of the process according to the invention, the doped polyazole films can also be produced by a process comprising the steps of
1) reacting one or more aromatic tetramino compounds with one or more aromatic carboxylic acids or esters thereof, which comprise at least two acid groups per carboxylic acid monomer, or one or more aromatic and/or heteroaromatic diaminocarboxylic acids in the melt at temperatures of up to 350° C., preferably up to 300° C.,
2) dissolving the solid prepolymer obtained in step 1) in polyphosphoric acid,
3) heating the solution obtainable according to step 2) under inert gas to temperatures of up to 300° C., preferably up to 280° C., to form the dissolved polyazole polymer,
4) forming a membrane using the solution of the polyazole polymer according to step 3) on a support and
5) treating the membrane formed in step 4) until it is self-supporting.

The process steps detailed in points 1) to 5) have been explained in detail above for steps A) to D), and reference is made thereto, especially with regard to preferred embodiments.

A membrane, especially a membrane based on polyazoles, can also be crosslinked at the surface by the action of heat in the presence of atmospheric oxygen. This curing of the membrane surface additionally improves the properties of the membrane. For this purpose, the membrane can be heated to a temperature of at least 150° C., preferably at least 200° C. and more preferably at least 250° C. The oxygen concentration in this process step is typically within the range from 5 to 50% by volume, preferably 10 to 40% by volume, without any intention that this should impose a restriction.

The crosslinking can also be effected by the action of IR or NIR (IR=InfraRed, i.e. light with a wavelength of more than 700 nm; NIR=Near IR, i.e. light with a wavelength in the range from approx. 700 to 2000 nm, or an energy in the range from approx. 0.6 to 1.75 eV). A further method is irradiation with β rays. The radiation dose here is between 5 and 200 kGy.

According to the desired degree of crosslinking, the duration of the crosslinking reaction may be within a wide range. In general, this reaction time is in the range from 1 second to 10 hours, preferably 1 minute to 1 hour, without any intention that this should impose a restriction.

Particularly preferred polymer membranes exhibit high performance. This is based particularly on improved proton conductivity. At temperatures of 120° C., the latter is at least 1 mS/cm, preferably at least 2 mS/cm, especially at least 5 mS/cm. These values are achieved here without moistening.

The specific conductivity is measured by means of impedance spectroscopy in a 4-pole arrangement in potentiostatic mode and using platinum electrodes (wire, diameter 0.25 mm). The distance between the current-collecting electrodes is 2 cm. The spectrum obtained is evaluated with a simple model consisting of a parallel arrangement of an ohmic resistance and a capacitance. The sample cross section of the phosphoric acid-doped membrane is measured immediately before the sample assembly. To measure the temperature dependence, the test cell is brought to the desired temperature in an oven and regulated by means of a Pt-100 thermocouple positioned in the immediate vicinity of the sample. After attainment of the temperature, the sample is held at this temperature for 10 minutes before the start of the measurement.

### Gas Diffusion Layer

The inventive membrane electrode assembly has two gas diffusion layers separated by the polymer electrolyte membrane. It is customary for this purpose to use flat, electrically conductive and acid-resistant structures. Examples of these include graphite fiber papers, carbon fiber papers, graphite fabrics and/or papers which have been rendered conductive by addition of carbon black. These layers achieve fine distribution of the gas and/or liquid flows. Suitable materials are sufficiently well known in the specialist field.

This layer generally has a thickness in the range from 80 μm to 2000 μm, especially 100 μm to 1000 μm and more preferably 150 μm to 500 μm.

In a particular embodiment, at least one of the gas diffusion layers may consist of a compressible material. In the context of the present invention, a compressible material is characterized by the property that the gas diffusion layer can be reduced by pressure to half, especially to a third, of its original size without losing its integrity.

This property is generally exhibited by gas diffusion layer composed of graphite fabric and/or graphite papers which have been rendered conductive by addition of carbon black. Typically, the gas diffusion layers are also optimized with regard to their hydrophobicity and mass transport properties the addition of further materials. In this context, the gas diffusion layers are modified with fluorinated or partly fluorinated materials, for example PTFE.

### Catalyst Layer

The catalyst layer(s) comprise(s) catalytically active substances. These include noble metals of the platinum group, i.e. Pt, Pd, Ir, Rh, Os, Ru, or else the noble metals Au and Ag. In addition, it is also possible to use alloys of all aforementioned metals. In addition, at least one catalyst layer may comprise alloys of the platinum group elements with base metals, for example Fe, Co, Ni, Cr, Mn, Zr, Ti, Ga, V etc. In addition, it is also possible to use the oxides of the aforementioned noble metals and/or base metals.

The catalytically active particles which comprise the aforementioned substances can be used in the form of metal powders, known as noble metal blacks, especially platinum and/or platinum alloys. Such particles generally have a size in the range from 5 nm to 200 nm, preferably in the range from 7 nm to 100 nm. What are called nanoparticles are also employed.

In addition, the metals can also be used on a support material. This support preferably comprises carbon, which can be used especially in the form of carbon black, graphite or graphitized carbon black. In addition, it is also possible to use electrically conductive metal oxides, for example SnOₓ, TiOₓ, or phosphates, for example FePOₓ, NbPOₓ, Zr_{y}(POₓ)_{z} as support material. In these formulae, the indices x, y and z denote the oxygen or metal content of the individual compounds, which may be within a known range, since the transition metals can assume different oxidation states.

The content of these supported metal particles, based on the total weight of the metal-support compound, is generally in the range from 1 to 80% by weight, preferably 5 to 60% by weight and more preferably 10 to 50% by weight, without any intention that this should impose a restriction. The particle size of the support, especially the size of the carbon particles, is preferably in the range from 20 to 1000 nm, especially 30 to 100 nm. The size of the metal particles present thereon is preferably in the range from 1 to 20 nm, especially 1 to 10 nm and more preferably 2 to 6 nm.

The sizes of the different particles are averages and can be determined by means of transmission electron microscopy or x-ray powder diffractometry.

The catalytically active particles detailed above can generally be obtained commercially.

In addition to the already commercially available catalysts or catalyst particles, it is also possible to use catalyst nanoparticles composed of platinum-containing alloys, especially based on Pt, Co and Cu, or Pt, Ni and Cu, in which the particles in the outer shell have a higher Pt content than those in the core. Such particles have been described by P. Strasser et al. in Angewandte Chemie 2007.

In addition, the catalytically active layer may comprise customary additives. These include fluoropolymers, for example polytetrafluoroethylene (PTFE), proton-conducting ionomers and surface-active substances.

In a particular embodiment of the present invention, the weight ratio of fluoropolymer to catalyst material comprising at least one noble metal and optionally one or more support materials is greater than 0.1, this ratio preferably being in the range from 0.2 to 0.6.

In a particular embodiment of the present invention, the catalyst layer has a thickness in the range from 1 to 1000 μm, especially from 5 to 500 μm, preferably from 10 to 300 μm. This value is a mean which can be determined by measuring the layer thickness in the cross section of images obtainable with a scanning electron microscope (SEM).

In a particular embodiment of the present invention, the noble metal content of the catalyst layer is 0.1 to 10.0 mg/cm², preferably 0.3 to 6.0 mg/cm² and more preferably 0.3 to 3.0 mg/cm². These values can be determined by elemental analysis of a flat sample.

The catalyst layer is generally not self-supporting, but rather is typically applied to the gas diffusion layer and/or the membrane. In this case, a portion of the catalyst layer can, for example, diffuse into the gas diffusion layer and/or the membrane, which forms transition layers. The result of this may also be that the catalyst layer can be regarded as part of the gas diffusion layer. The thickness of the catalyst layer results from the measurement of the thickness of the layer to which the catalyst layer has been applied, for example the gas diffusion layer or the membrane, this measurement giving the sum of the catalyst layer and the layer in question, for example the sum of gas diffusion layer and catalyst layer. The catalyst layers preferably have gradients, which means that the noble metal content increases toward the membrane, while the content of hydrophobic materials has the reverse behavior.

For further information about membrane electrode assemblies, reference is made to the specialist literature, especially to the patent applications WO 01/18894 A2, DE 195 09 748, DE 195 09 749, WO 00/26982, WO 92/15121 and DE 197 57 492. The disclosure present in the aforementioned references with regard to the structure and production of membrane electrode assemblies, and the electrodes, gas diffusion layers and catalysts to be selected, also forms part of the description.

### Seals

For better handling and for prevention of leaks between the gas diffusion layer/electrode and the proton-conducting polymer electrolyte membrane or matrix, seals can be used.

These seals are preferably formed from fusible polymers belonging to the class of the fluoropolymers, for example poly(tetrafluoroethylene-co-hexafluoropropylene) FEP, polyvinylidene fluoride PVDF, perfluoroalkoxy polymer PFA, poly(tetrafluoroethylene-co-perfluoro(methyl vinyl ether)) MFA. These polymers are in many cases commercially available, for example under the Hostafon®, Hyflon®, Teflon®, Dyneon® and Nowoflon® tradenames.

In addition, the seal materials may also be produced from polyphenylenes, phenol resins, phenoxy resins, polysulfide ethers, polyphenylene sulfide, polyether sulfones, polyimines, polyether imines, polyazoles, polybenzimidazoles, polybenzoxazoles, polybenzthiazoles, polybenzoxadiazoles, polybenztriazoles, polyphosphazenes, polyether ketones, polyketones, polyether ether ketones, polyether ketone ketones, polyphenyleneamides, polyphenylene oxides and mixtures of two or more of these polymers.

In addition to the aforementioned materials, it is also possible to use seal materials based on polyimides. The class of the polymers based on polyimides also includes polymers which, as well as imide groups, also contain amide groups (polyamide imides), ester groups (polyester imides) and ether groups (polyether imides) as a constitute of the main chain.

Preferred polyimides have repeat units of the formula (VI)

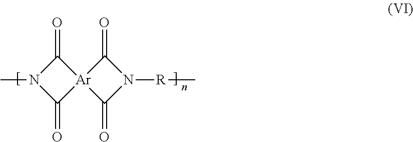

in which the Ar radical is as defined above and the R radical is an alkyl group or a divalent aromatic or heteroaromatic group having 1 to 40 carbon atoms. The R radical is preferably a divalent aromatic or heteroaromatic group which derives from benzene, naphthalene, biphenyl, diphenyl ether, diphenyl ketone, diphenylmethane, diphenyldimethylmethane, bisphenone, diphenyl sulfone, quinoline, pyridine, bipyridine, anthracene, thiadiazole and phenanthrene, which may optionally also be substituted. The index n then indicates that the repeat units are part of polymers.

Such polyimides are commercially available under the ®Kapton, ®Vespel, ®Toray and ®Pyralin tradenames from DuPont and ®Ultem tradename from GE Plastics and ®Upilex tradename from Ube Industries.

The thickness of the seals is preferably in the range from 5 μm to 1000 μm, especially 10 μm to 500 μm and more preferably 25 μm to 100 μm.

The seals may also be of multilayer structure. In this embodiment, different layers are bonded to one another using suitable polymers, fluoropolymers in particular being of good suitability for formation of a corresponding bond. Suitable fluoropolymers are known in the specialist field. These include polytetrafluoroethylene (PTFE) and poly(tetrafluorethylene-co-hexafluoropropylene) (FEP). The layer of fluoropolymers present on the above-described sealing layers generally has a thickness of at least 0.5 μm, especially of at least 2.5 μm. This layer may be provided between the polymer electrolyte membrane and the polyimide layer. In addition, the layer may also be applied on the side facing away from the polymer electrolyte membrane. In addition, both surfaces of the polyimide layer can be provided with a layer of fluoropolymers. This can improve the long-term stability of the MEAs.

Polyimide films which have been provided with fluoropolymers and can be used in accordance with the invention are commercially available under the ®Kapton FN tradename from DuPont.

The above-described seals and seal materials can also be used between the gas diffusion layer and the bipolar plate, such that at least one sealing frame is in contact with the electrically conductive separator or bipolar plates.

### Bipolar Plates

The bipolar plates or else separator plates are typically provided with flowfield channels on the sides facing the gas diffusion layers, in order to enable the distribution of reactant fluids. The separator or bipolar plates are typically produced from graphite or from conductive, heat-resistant polymer. In addition, it is customary to use carbon composites, conductive ceramics, or metallic materials. This enumeration merely gives examples and is not limiting.

The thickness of the bipolar plates is preferably in the range from 0.2 to 10 mm, especially in the range from 0.2 to 5 mm and more preferably in the range from 0.2 to 3 mm. The specific resistivity of the bipolar plates is typically less than 1000 μOhm*m

The production of the inventive membrane electrode assembly is obvious to the person skilled in the art. In general, the different constituents of the membrane electrode assembly are placed one on top of another and bonded to one another by pressure and temperature. In general, lamination is effected at a temperature in the range from 10 to 300° C., especially 20 to 200° C., and with a pressure in the range from 1 to 1000 bar, especially from 3 to 300 bar. In this context, a precaution which prevents damage to the membrane in the inner region is typically taken. For example, it is possible for this purpose to use a shim, i.e. a spacer.

In a particular aspect of the present invention, the production of the MEAs here can preferably be effected continuously.

The finished membrane electrode assembly (MEA) is ready for operation after cooling and can—provided with bipolar plates—be used in a fuel cell.

For operation of the fuel cell, the gaseous fuels are supplied via the gas channels present in the bipolar plates.

On the anode side, a hydrogenous gas is supplied. The hydrogenous gas may be pure hydrogen or a hydrogen-comprising gas, especially what are called reformates, i.e. gases which are produced in an upstream reforming step from hydrocarbons. The hydrogenous gas comprises typically at least 20% by volume of hydrogen.

According to the invention, at least one electrolyte responsible for proton conduction is added to the hydrogenous gas, such that at least 50% of the saturation vapor pressure of the electrolyte, preferably at least 75% of the saturation vapor pressure, is attained under the operating conditions of the fuel cell (pressure and temperature). The electrolyte added is preferably the same electrolyte which is already present in the polymer electrolyte membrane or the polymer electrolyte matrix.

More preferably, the hydrogenous gas supplied is fully saturated with the electrolyte responsible for proton conduction. In this context, the saturation of the hydrogenous gas is determined by the operating temperature and the operating pressure of the fuel cell. The inventive fuel cell is normally operated within a range from at least 0° C. to at most 220° C. at operating pressures from standard pressure up to a maximum of 4 bar gauge.

The bipolar plates used in accordance with the invention have, on the side of the bipolar plate facing the anode-side gas diffusion layer or the gas diffusion electrode (anode), a porosity of at least 80%, preferably at least 65%, more preferably at least 50%. In this embodiment, any diffusion of the volatile electrolyte which is otherwise to be observed due to partial vapor pressure differences from the anode side to the cathode side is prevented or reduced.

The side of the bipolar plate facing the anode-side gas diffusion layer or the gas diffusion electrode (anode) is capable of forming a reservoir for the electrolyte due to a selected porosity. The open pores of the bipolar plate are filled and replenished with electrolyte, such that it is enriched in accordance with the invention in the hydrogenous gas supplied.

The filling of the above reservoir located in the porous region of the bipolar plate can be effected by addition of the electrolyte to the hydrogenous gas or by separate supply of the previously vaporized electrolyte to the porous region of the bipolar plate.

In a further configuration of the process, the electrolyte discharged on the cathode side of the fuel cell is collected and supplied to the hydrogenous gas or to the reservoir on the anode side. To increase efficiency, the discharged electrolyte can be collected by means of cold traps and/or heat exchangers such that the temperature goes below the dew point of the electrolyte and it condenses. The condensed electrolyte can, before it is supplied to the hydrogenous gas on the anode side, be purified or concentrated and/or degassed.

In a further, likewise preferred embodiment of the process, the gas mixture comprising oxygen and nitrogen is thus also admixed with at least one electrolyte responsible for proton conduction, such that, under the operating conditions of the fuel cell (pressure and temperature), at least 50% of the saturation vapor pressure of the electrolyte, preferably at least 75% of the saturation vapor pressure, is attained. The electrolyte added is preferably the same electrolyte which is already present in the polymer electrolyte membrane or the polymer electrolyte matrix.

More preferably, the supplied gas mixture comprising oxygen and nitrogen is fully saturated with the electrolyte responsible for the proton conduction. In this context, the saturation of the hydrogenous gas is determined by the operating temperature and the operating pressure of the fuel cell. The inventive fuel cell is normally operated within a range from at least 0° C. to a maximum of 220° C. at operating pressures from standard pressure up to a maximum of 4 bar gauge.

The bipolar plates used in accordance with the invention additionally have, on the side of the bipolar plate facing the cathode-side gas diffusion layer or the gas diffusion electrode (cathode), a porosity of at least 80%, preferably at least 65%, more preferably at least 50%. In this embodiment, any additional diffusion of the volatile electrolyte which is otherwise to be observed due to partial vapor pressure differences from the anode side to the cathode side is prevented or reduced.

The side of the bipolar plate facing the cathode-side gas diffusion layer or the gas diffusion electrode (cathode) is likewise capable of forming a reservoir for the electrolyte due to a selected porosity. The open pores of the bipolar plate are filled and replenished with electrolyte, such that it is enriched in accordance with the invention in the supplied gas mixture comprising oxygen and nitrogen. The electrolyte can be added in the same way as on the anode side.

In a preferred embodiment of the process according to the invention, both the gas mixture comprising oxygen and nitrogen supplied on the cathode side and the hydrogenous gas supplied on the anode side are provided with the electrolyte responsible for the proton conduction. This prevents or reduces diffusion of the electrolyte in the membrane electrode assembly and the adjacent bipolar plates.

In a particularly preferred embodiment of the process according to the invention, the mass balance of the volatile electrolyte responsible for the proton conduction is detected, and at least the mass of electrolyte which is discharged by the offgas on the cathode side is supplied on the anode side.

By means of the process according to the invention, better operation is possible in fuel cells which have a proton-conducting polymer electrolyte membrane or polymer electrolyte matrix which has at least one electrolyte whose partial vapor pressure at 100° C. is below 0.300 bar, preferably below 0.250 bar and more preferably below 0.200 bar, and they exhibit improved lifetime.

The hydrogenous gas is supplied on the anode side ideally at ambient pressure with flow rates in the region of a maximum double stoichiometric excess. However, it is also possible to operate the supply of the hydrogenous gas up to a pressure of 4 bar gauge.

When the proton-conducting polymer electrolyte membrane or polymer electrolyte matrix used is one which conducts protons by the Grotthus mechanism, the fuel cell can also be operated at temperatures above 100° C., and more particularly without moistening of the burner gas.

Higher operating temperatures, especially above 120° C., allow the use of pure platinum catalysts, i.e. without a further alloy constituent, have a high tolerance to carbon monoxide. Thus, operation with reformates is possible. At temperatures of 160° C., it is possible, for example, for more than 1% by volume of CO to be present in the fuel gas, without this leading to a noticeable reduction in the performance of the fuel cell.

When the proton-conducting polymer electrolyte membrane or polymer electrolyte matrix conducts protons based on the Grotthus mechanism, but especially when basic polymers are used, more preferably based on polyazoles which comprise acids or acid-containing compounds, the hydrogenous gas may comprise up to 5% by volume of CO.

On the cathode side, a gas mixture comprising at least oxygen and nitrogen is supplied. This gas mixture acts as an oxidant. In addition to gas mixtures of oxygen and nitrogen which do not occur naturally, i.e. are synthetic, air is preferred as the gas mixture.

The gas mixture comprising at least oxygen and nitrogen is ideally supplied at ambient pressure on the cathode side at flow rates in the region of a maximum of a five-fold stoichiometric excess.

However, it is also possible to conduct the supply of the gas mixture comprising at least oxygen and nitrogen up to a pressure of 4 bar gauge.

As already stated above, the bipolar plates used in accordance with the invention at least on the anode side have, on the side facing the anode-side gas diffusion layer or the gas diffusion electrode (anode), a porosity of at least 80%, preferably at least 65%, more preferably at least 50%.

In a further preferred embodiment, the entire bipolar plate has the aforementioned porosity in the electrochemically active region and is thus capable of replacing spent electrolyte by diffusion into the region provided with the gas channels. The bipolar plates used in accordance with the invention have the inventive porosity in the electrochemically active region, but are configured in the edge region such that they can accommodate a seal or gas seal. The edge region of the bipolar plate used in accordance with the invention thus does not have the inventive porosity.

The supply of the spent electrolyte and the replenishment of the porous bipolar plate with fresh electrolyte can be effected by means of microdosage. The electrolyte needed for this purpose can be stored in a reservoir or supply vessel, which may be integrated in the fuel cell or the fuel cell stack. It is also possible to use an external reservoir or supply vessel.

The present invention further provides an electrochemical cell, especially a single fuel cell, comprising
(i) a proton-conducting polymer electrolyte membrane or polymer electrolyte matrix which has at least one electrolyte whose partial vapor pressure at 100° C. is below 0.300 bar, preferably below 0.250 bar and more preferably below 0.200 bar,
(ii) at least one catalyst layer present on both sides of the proton-conducting polymer electrolyte membrane or polymer electrolyte matrix,
(iii) at least one electrically conductive gas diffusion layer present on the two outer sides of the catalyst layer,
(iv) at least one bipolar plate with integrated media channels each present on the side of the gas diffusion layer facing away from the catalyst layer,
   wherein at least the side of the bipolar plate facing the anode-side gas diffusion layer or the gas diffusion electrode (anode) has a porosity of at least 80%, preferably at least 65%, more preferably at least 50%.

As already explained, a bipolar plate of such a configuration is capable of forming a reservoir for the electrolyte due to a selected porosity. The open pores of the bipolar plate are filled and replenished with electrolyte, such that it is enriched in the gas supplied. The open pores can also be filled with electrolyte actually before the assembly of the single cell. For this purpose, the open-pore side of the bipolar plate can be wetted or impregnated with electrolyte.

In a preferred embodiment, the entire bipolar plate has the aforementioned porosity in the electrochemically active region and is thus capable of replacing spent electrolyte by diffusion into the region provided with the gas channels. The bipolar plates used in accordance with the invention have the inventive porosity in the electrochemically active region, but are configured in the edge region such that they can accommodate a seal or gas seal. The edge region of the bipolar plate used in accordance with the invention thus does not have the inventive porosity.

The bipolar plates used in accordance with the invention have, at least on the side facing the anode-side gas diffusion layer or the gas diffusion electrode (anode), a porosity of at least 80%, preferably at least 65%, more preferably at least 50%, especially in the region of the integrated media channels.

In a further preferred embodiment, the entire bipolar plate has the aforementioned porosity and is thus capable of replacing spent electrolyte by diffusion into the region provided with the gas channels.

In a further, likewise preferred embodiment of the invention, the side of the bipolar plate facing the cathode-side gas diffusion layer or the gas diffusion electrode (cathode) also has a porosity of at least 80%, preferably at least 65%, more preferably at least 50%, especially in the region of the integrated media channels.

In a further preferred embodiment, the entire bipolar plate on the cathode side has the aforementioned porosity and is thus capable of replacing spent electrolyte by diffusion into the region provided with the gas channels.

The supply of the spent electrolyte and the replenishment of the porous bipolar plate with fresh electrolyte can be effected by means of microdosage. The electrolyte needed for this purpose can be stored in a reservoir or supply vessel, which may be integrated in the fuel cell or the fuel cell stack. It is also possible to use an external reservoir or supply vessel.

The bipolar plates used in accordance with the invention have, at least on the side facing the anode-side gas diffusion layer or the gas diffusion electrode (anode), a porosity of at least 80%, preferably at least 65%, more preferably at least 50%, especially in the region of the integrated media channels, the porous region of the bipolar plate being located in the region of the surface of the bipolar plate. The thickness of the porous region is up to 30% of the total thickness of the bipolar plate. Preferably, the bipolar plate used in accordance with the invention has the inventive porous region on both sides, which are separated from one another by a gas-tight core. It is thus ensured that the two gases supplied are not mixed with one another or mixed by diffusion.

The inventive porosity is determined by means of mercury porosimetry (Hg porosimetry). This involves determining, with the aid of a commercial porosimeter (Porotec Pascal 440), the amount of mercury which can be adsorbed in the porous medium as a function of pressure. The porosity is defined by the ratio of the Hg volume absorbed to the total volume of the porous body. The total volume of the test sample can be determined geometrically or from weight and density. To determine the sample porosity, the sample is weighed and evacuated at 10⁻⁵ MPa for 15 minutes, and then the pores of the sample are filled with liquid Hg by gradually increasing the pressure from 0.01 MPa to 400 MPa. On completion of the measurement, the pore volume is determined from the increase in weight of the sample, which is determined by the Hg absorption, and the density of mercury. The porosity is then calculated from the ratio of the pore volume to the total sample volume.

The present invention further provides electrochemical cells, especially fuel cells or fuel cell systems, comprising at least one of the inventive single electrochemical cells.

1-33. (canceled)

34. A process for operating a fuel cell comprising
i. a proton-conducting polymer electrolyte membrane or polymer electrolyte matrix which has at least one electrolyte whose partial vapor pressure at 100° C. is below 0.300 bar, at least one catalyst layer present on both sides of the proton-conducting polymer electrolyte membrane or polymer electrolyte matrix,
ii. at least one electrically conductive gas diffusion layer present on the two outer sides of the catalyst layer,
iii. at least one bipolar plate present on the two outer sides of the gas diffusion layer, comprising the following steps:
a) supplying a hydrogenous gas by means of the gas channels present in the bipolar plate through the gas diffusion layer to the catalyst layer on the anode side,
b) supplying a gas mixture comprising oxygen and nitrogen by means of the gas channels present in the bipolar plate through the gas diffusion layer to the catalyst layer on the cathode side,
c) generating protons at the catalyst layer on the anode side,
d) diffusing the protons generated through the proton-conducting polymer electrolyte membrane or polymer electrolyte matrix,
e) reacting the protons with the oxygenous gas supplied on the cathode side,
f) tapping of the voltage potential formed via the bipolar plates on the anode side and on the cathode side,
wherein at least the hydrogenous gas supplied is enriched with at least one electrolyte which is responsible for the proton conduction and whose partial vapor pressure at 100° C. is below 0.300 bar.

35. The process according to claim 34, wherein the proton-conducting polymer electrolyte membrane comprises materials in which the polymer has at least one covalently bonded acid or in which the polymer has been doped with an acid.

36. The process according to claim 34, wherein the proton-conducting polymer electrolyte matrix comprises at least one basic polymer and at least one acid.

37. The process according to claim 34, wherein the proton-conducting polymer electrolyte membrane or polymer electrolyte matrix is a blend of at least two different polymers.

38. The process according to claim 34, wherein the fuel cell has a proton-conducting polymer electrolyte membrane or proton-conducting polymer electrolyte matrix which comprises at least one basic polymer and at least one acid and is operated at temperatures above 100° C. without additional moistening of the hydrogenous gas.

39. The process according to claim 38, wherein the fuel cell is operated at temperatures above 120° C.

40. The process according to claim 34, wherein the hydrogenous gas is pure hydrogen or a gas comprising at least 20% by volume of hydrogen.

41. The process according to claim 34, wherein at least one electrolyte responsible for the proton conduction is added to the hydrogenous gas such that at least 50% of the saturation vapor pressure of the electrolyte is attained under the operating conditions of the fuel cell.

42. The process according to claim 41, wherein the saturation vapor pressure of the electrolyte is at least 75%.

43. The process according to claim 34, wherein the hydrogenous gas supplied is fully saturated with the electrolyte responsible for the proton conduction under the operating conditions of the fuel cell.

44. The process according to claim 34, wherein the electrolyte is added to the hydrogenous gas by supply of the electrolyte which has been evaporated beforehand, or by passing the hydrogenous gas through the liquid electrolyte.

45. The process according to claim 34, wherein the electrolyte is added to the hydrogenous gas in liquid and/or gaseous form by means of microdosage.

46. The process according to claim 34, wherein the electrolyte is added from a reservoir or supply vessel integrated into the fuel cell or the fuel cell stack.

47. The process according to claim 34, wherein the electrolyte discharged on the cathode side of the fuel cell is collected and supplied to the hydrogenous gas on the anode side.

48. The process according to claim 47, wherein the electrolyte discharged is collected by means of cold traps and/or heat exchangers.

49. The process according to claim 48, wherein the condensed electrolyte, before it is supplied to the hydrogenous gas on the anode side, is purified and/or concentrated and/or degassed.

50. The process according to claim 34, wherein the gas mixture comprising oxygen and nitrogen is also added at least one electrolyte responsible for the proton conduction, such that at least 50% of the saturation vapor pressure of the electrolyte is attained under the operating conditions of the fuel cell.

51. The process according to claim 50, wherein the saturation vapor pressure of the electrolyte is at least 75%.

52. The process according to claim 50, wherein the supplied gas mixture comprising oxygen and nitrogen is fully saturated with the electrolyte responsible for the proton conduction under the operating conditions of the fuel cell.

53. The process according to claim 50, wherein the electrolyte can be added to the gas mixture comprising oxygen and nitrogen in the same manner as on the anode side.

54. The process according to claim 34, wherein both the gas mixture comprising oxygen and nitrogen supplied on the cathode side and the hydrogenous gas supplied on the anode side are provided with the electrolyte responsible for the proton conduction.

55. The process according to claim 34, wherein the mass balance of the volatile electrolyte responsible for the proton conduction is detected and at least the mass of electrolyte which is discharged by the offgas on the cathode side is supplied on the anode side.

56. The process according to claim 34, wherein the hydrogenous gas is a reformate which is produced from hydrocarbons in an upstream reforming step.

57. The process according to claim 34, wherein the hydrogenous gas is supplied at ambient pressure and the flow rates are no higher than within the region of the double stoichiometric excess.

58. The process according to claim 34, wherein the gas mixture comprising at least oxygen and nitrogen is supplied on the cathode side preferably at ambient pressure, and the flow rates are in the region of not more than a 5-fold stoichiometric excess.

59. An electrochemical cell comprising
(i) a proton-conducting polymer electrolyte membrane or polymer electrolyte matrix which has at least one electrolyte whose partial vapor pressure at 100° C. is below 0.300 bar,
(ii) at least one catalyst layer present on both sides of the proton-conducting polymer electrolyte membrane or polymer electrolyte matrix,
(iii) at least one electrically conductive gas diffusion layer present on the two outer sides of the catalyst layer,
(iv) at least one bipolar plate with integrated media channels each present on the side of the gas diffusion layer facing away from the catalyst layer,
wherein at least the side of the bipolar plate facing the anode-side gas diffusion layer or the gas diffusion electrode (anode) has a porosity of at least 80%.

60. The electrochemical cell according to claim 59, wherein the entire bipolar plate has the porosity specified in the electrochemically active region, in the region of the integrated media channels.

61. The electrochemical cell according to claim 59, wherein the bipolar plate is configured in the edge region such that it can accommodate a seal or gas seal.

62. The electrochemical cell according to claim 59, wherein the side of the bipolar plate facing the cathode-side gas diffusion layer or the gas diffusion electrode (cathode) has a porosity of at least 80%.

63. The electrochemical cell according to claim 59, wherein the porous region of the bipolar plate is located in the region of the surface of the bipolar plate and the cathode has a porosity of at least 50 in the region of the integrated media channels.

64. The electrochemical cell according to claim 63, wherein the thickness of the porous region is up to 30% of the total thickness of the bipolar plate.

65. The electrochemical cell according to claim 63, wherein the bipolar plate has a porous region on both sides, in the region of the surface of the bipolar plate, and the two porous regions are separated from one another by a gas-tight core in the bipolar plate.

66. A fuel cell system comprising at least one single fuel cell defined in claim 59.
